(19) United States
(12) Patent Application Publication
(10) Pub. No.: US 2005/0149410 A1
(43) Pub. Date: Jul. 7, 2005

(54) Process and system for matching buyers and sellers of goods and/or services

(76) Inventor: Jeffery A. Livesay, Houston, TX (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/076,071

(22) Filed: Mar. 8, 2005

Related U.S. Application Data
(63) Continuation of application No. 09/672,938, filed on Sep. 28, 2000.
(60) Provisional application No. 60/157,315, filed on Oct. 1, 1999.
(60) Provisional application No. 60/166,960, filed on Nov. 23, 1999.

(51) Int. Cl. G06F 17/60

(52) U.S. Cl. 705/26

(57) ABSTRACT

The present invention provides a process and a system for matching buyers and sellers of goods and/or services for a project. The invention enables a buyer to specify a project in terms of physical, functional, temporal, financial, and/or transactional parameters which are then automatically converted, by the present invention, into at least one request for goods/services needed to complete the project. The requests are suitably provided to at least one seller, who may be pre-identified by the buyer as a preferred seller. Upon receiving a request, the seller may submit a response to the request, as desired. Additionally, the invention provides a forum for the negotiation of any agreements and the formation of contracts to provide the requested, or alternative goods/services. Further, the present invention provides a system and process for targeting marketing to online buyers based upon profiles established for the buyers, profiles for the sellers, and the current on-line activities of a buyer. The targeted marketing features are preferably provided by utilizing Profile links which provide hyper links to a web page associated with a seller.

### CROSS REFERENCE TO RELATED APPLICATIONS

This application is related to the following applications, which are incorporated herein by reference: U.S. Provisional Application No. 60/157,315, of Jeffery A. Livesay, entitled “METHOD AND AUTOMATED PROCESS FOR MATCHING BUYERS AND SELLERS OF GOODS AND/OR SERVICES”, and filed on Oct. 1, 1999; and U.S. Provisional Application No. 60/166,960, of Jeffery A. Livesay, entitled “METHOD AND SYSTEM OF PROVIDING PROFILE LINK BASED INTERNET ADVERTISING”, and filed on Nov. 23, 1999.

### FIELD OF THE INVENTION

The present invention relates in general to the field of automated business processes which match buyers with sellers of goods and/or services while also targeting marketing to such buyers. More specifically, the present invention relates to an automated process which receives specifications of physical, functional, temporal, financial, transactional and/or geographical parameters from buyers, and matches the buyers with sellers of such goods and/or services which satisfy the parameters and specifications. Additionally, the present invention provides targeted marketing capabilities to such buyers based upon profile links to sellers provided via a network.

### BACKGROUND OF THE INVENTION

In today's fast paced economy, many projects exist which require various goods and/or services to be provided by numerous organizations (hereafter, “sellers”) while also requiring relationships for providing and monitoring such goods/services to be quickly and efficiently established. Examples of such projects include drilling for oil, commercial and/or residential construction, manufacturing complex objects (for example, aircraft and special use objects), and providing specialized services (for example, brokering excess power and bandwidth, and developing unique software products). When planning such projects, the person(s) responsible for the project (hereinafter, the “buyer”) is often faced with the daunting tasks of: (1) determining which goods/services are needed; (2) determining who provides such goods/services (i.e., who are the “sellers”); (3) establishing a dialogue with such sellers; (4) selecting at least one seller; (5) undertaking, starting and monitoring the project until completion or termination; (5) facilitating post-completion tasks (for example, paying sellers and other back-end processing); and (6) attempting to identify areas of improvement for future projects.

Commonly, when faced with such a challenge, many buyers rely upon antiquated systems and processes for accomplishing those tasks necessary to see an project through from start to post-completion. Such antiquated systems include utilizing business listings and other directories to identify sellers, negotiating agreements with the sellers via fax, telephone, and other non-real-time responsive systems, and making best guest judgments as to areas in which future improvements may be realized. As a result, many buyers relying upon such antiquated processes are often left behind in today's fast paced, Internet driven information economy. As such, a system is needed which allows buyers to be efficiently matched with sellers, and projects monitored and coordinated through all phases of the project.

For example, when constructing a building, a general contractor must decide which seller will provide excavation services, what type of materials to use, when the materials will be used, who will supply the materials, who will use the materials (i.e., who will actually construct the building) and other various factors. Currently, when constructing a building, the builder will often use a Rolodex® to determine which preferred sellers provide the desired goods/services. Upon identifying the sellers, the buyer may then engage in some dialogue with the seller about the project parameters, and may solicit bids. Since each seller may identify a unique manner for accomplishing the specified task, the buyer is often left with trying to determine which seller is providing the best value, the best approach, the best timeliness, etc. Since such determinations can be quite time consuming, buyers generally do not have time to shop for other than a limited number of sellers for any given project. As such, new sellers on the market, and/or new techniques may often be overlooked.

Further compounding the problems faced by buyers in identifying and coordinating goods/services from sellers is the fact that sellers often dictate which of the numerous currently available processes for processing goods/services to use (e.g., auction, fixed price and quantity systems, and other systems well known in the art). For some of these processes, most of the essential terms of the agreement are dictated or controlled by the seller, with the buyer having little input over price, delivery terms, location, quantity, etc. (examples of such seller driven processes include retail, mail order, telephone, and some on-line sales systems). For example, a builder desiring to procure nails might be required by a retail sales process or an on-line sales process to purchase nails only in bundles of 200, for a set price. Since the buyer can not modify the goods/services or terms or conditions of the procurement process, the buyer's needs are often inadequately, untimely, and inefficiently fulfilled.

Additionally, recent automation of the aforementioned seller driven processes (for example, via the Internet) has not adequately addressed this problem. While the new automated processes generally enable a buyer to shop for goods and/or services without having to travel to the seller's location or obtain a catalog, such processes are commonly characterized by sellers offering items of commerce under seller specified terms and conditions. Such processes do not allow a buyer to identify a project in terms of its specifications, and have the specifications translated into requests for goods/services which are then fulfilled in a timely and efficient manner by a seller providing the requested goods/services or suitable alternatives. Additionally, such processes often do not identify sellers of specialty goods/services and, therefore, are often inadequate for the provisioning of goods and/or services which are not commonly mass marketed. In short, a more efficient process of matching buyers and sellers is needed.

Similarly, currently available buyer driven processes also do not facilitate the efficient matching of buyers and sellers. Examples of commonly available buyer driven processes include bidding processes and auctions. Regardless of the process (whether bid based or auction based), a buyer is generally first required to identify specific goods/services which are needed to complete a project. None of the processes allow a buyer to specify a project in terms of project details which are then automatically converted into requests for proposals, requests for specific goods, or other such proposals. As is appreciated by those skilled in the art, converting specifications for complex projects into specific requests for goods/services is extremely time consuming, is often incomplete, and is extremely inefficient because the buyers often can not precisely identify and/or specify those goods/services available and needed to fulfill a project. As such, today's buyer driven processes do not provide the degree of flexibility, specificity, and efficiency necessary for many buyers of goods/services. Therefore, a process is needed which enables a buyer to procure those goods/services necessary to undertake and complete a project by providing a project's specifications to an automated process which facilitates the conversion of such specifications into requests for goods/service and matches the buyer with sellers of such goods/services.

Additionally, once an agreement has been entered into to provide goods/services needed to fulfill a project, systems are not available which enable both buyers and sellers to monitor the progress of the project, efficiently implement design changes, provide billing and other back-office functions, and determine areas for improvement by utilizing knowledge based systems. Thus, a system is needed which enables buyers/sellers to enter into agreements for projects and monitor such projects from initialization through post-completion/termination.

Further, with the advent of the Internet as another medium for the marketing of goods/services, sellers have sought efficient and useful mechanisms for marketing their goods/services to buyers via web pages. In order to encourage buyers to visit the seller's web pages, at which their goods/services are often offered for sale or identified, sellers utilize various marketing mechanisms including: static marketing (where an advertisement is displayed as a static graphic or textual description on a portion of a buyer's computer screen); flash marketing (when an advertisement is flashed on the buyer's screen for a brief time period); banner marketing (wherein a “billboard” providing a hyper-link to the seller's web page is provided on a portion of a web page the buyer is currently viewing); and various other marketing mechanisms. In spite of these various and numerous methods of marketing via the Internet and other networks, such methods have been shown to be very inefficient in promoting goods/services because such methods do not generally provide targeted marketing to buyers when they are most likely to consider acquiring a sellers goods/services, for example when they are undertaking a project in which the seller's goods/services may be utilized.

Therefore, a new method for providing marketing to buyers is needed. More specifically, a system and process is needed which combines the efficiencies and unique capabilities of the present invention, as explained further herein, to match buyers with sellers of goods/services.

### SUMMARY OF THE INVENTION

The present invention is directed to a process and system which matches buyers and sellers of goods/services based upon specifications provided by a buyer for a project. Additionally, the present invention provides a forum for the negotiation and resulting agreements to provide goods/services needed for a project, while also allowing buyers and sellers to monitor the status of the project and/or the provisioning of the agreed upon goods/services. Further, the invention facilitates the completion of post task accomplishment activities such as back-end accounting and billing operations, resource management, and knowledge management. Lastly, the present invention provides a process and system for providing targeted marketing by sellers to buyers during all phases of a project including project initialization, monitoring, and post-completion phases.

More specifically, the present invention provides a system and process which, upon identification of specifications for a project by a buyer, generates a request for goods and/or services needed to fulfill the project and provides the request to those sellers designated by the buyer and/or those sellers which can provide the requested goods/services. In response to such requests, the sellers may submit bids, request additional information, recommend changes to project parameters and/or the goods/services requested, and perform various other activities. The present invention enables sellers to directly communicate with the buyer, including providing documents and other information which are readily accessible by both the buyer, the sellers, and others (engineers, other project members, etc.) from anywhere, at any time, via a suitable communications link. In this manner, the process facilitates the matching of buyers with sellers of goods/services based upon project parameters, and not necessarily upon the specific identification of goods/services by a buyer. Additionally, it is to be appreciated that a “project”, as used in this specification, includes activities involving single steps (for example, procuring casing for a well) as well as activities involving numerous steps (for example, building a house), and is not to be construed as being limited to any specific classes of goods, services, activities, or projects.

More specifically, when utilizing the systems and/or processes of the present invention, a buyer specifies parameters which describe a project. Examples of such parameters include the following: physical parameters (e.g., size, weight, height); functional parameters (e.g., able to accelerate from 0 to 60 m.p.h. in less then 6.0 seconds); temporal parameters (e.g., to be delivered by Tuesday); financial parameters (e.g., to cost less than $10.00); transactional parameters (e.g., to be paid by check or money order); and/or geographical parameters (e.g., located in Colorado). The physical, functional, temporal, financial, and/or geographical parameters are hereafter collectively referred to as “Parameters”.

Additionally, it is to be appreciated that the present invention may be accomplished using any system, automaton, and/or “Turing machine.” An “automaton” is herein described as a mechanism which is relatively self operating and designed to follow a predetermined sequence of operations or respond to encoded instructions. A “Turing machine” is herein described as an abstract expression of a computing device which may be realized or implemented on an infinite number of different physical computing devices. Examples of systems, automatons and/or Turing machines which may be utilized in performing the process of the present invention include, but are not limited to: electrical computers (for example, an IBM personal computer); neuro-computers (for example, one similar to the “General Purpose Neural Computer” described in U.S. Pat. No. 5,155,802, issued to Paul H. Mueller, on Oct. 13, 1992); molecular computers (for example, one similar to the “Molecular Automata Utilizing Single or Double-Strand Oligonucleotides” described in U.S. Pat. No. 5,804,373, issued to Allan Lee Schweiter et. al., on Sep. 8, 1998); biological computers (for example, one similar to the biological computer presented by Ehud Shapiro, of the Computer Science and Applied Mathematics Department at the Weizman Instutite of Science (Rehovot, Israel), at the Fifth International Meeting on DNA-Based Computers); and optical computers. For purposes of simplicity, such devices hereinafter are referred to as “computers”, as is commonly understood in the art. But, the invention is not limited to such devices and may be accomplished upon any system or collection of systems capable of providing the features and functions identified herein.

Additionally, when providing the before mentioned marketing capabilities, the present invention preferably associates buyer profile information with identifications of seller provided goods/services to target the marketing to the buyer. The profile information may be based upon any act, information, or event supplied or accomplished by the buyer including, for example, an on-line application or Internet site currently being visited by the buyer, answers to a questionnaire, and other information. More specifically, the present invention preferably accesses databases which maintain profiles of buyers. Such profiles may include factors such as the location of the buyer, various Parameters, buyer characteristics, web site access history, and preferred seller lists. Throughout this specification, the profile information is preferably accessed by a “Profile link”—which is herein defined to include any process or system for providing profile information for a seller or a buyer to another buyer or seller. Additionally, in the preferred embodiment, a Profile link is a hyper-link to an associated web page. However, those skilled in the art appreciate that process or system for providing profile information may be utilized by and/or in conjunction with the present invention.

The present invention also preferably utilizes databases of sellers within which profiles have been established to determine which sellers and which goods/services are to be targeted to the various buyers at any time via a Profile link. For example, a database on seller XYZ may indicate that XYZ provides goods in categories 1, 2 and 3. When buyer ABC accesses an on-line site or an application wherein goods in category number 2 are utilized, the present invention recognizes that XYZ provides such goods, and provides targeted marketing about XYZ's capabilities or products to ABC, via a Profile link, provided with the information page ABC is currently reviewing. The present invention may also recognize that ABC, for whatever reason, does not wish to engage in business with XYZ, or vice versa and thus, does not provide a Profile link to XYZ's information. Thus, the present invention utilizes Profile links to target the marketing of goods/services to those most likely in need of such goods/services, especially while a buyer is actively pursuing the procurement of such goods/services.

Therefore, in addition to the aforementioned features and those identified hereafter, the present invention provides a method for targeting marketing to online buyers based upon profiles established for buyers, profiles established for sellers, and the current on-line activities of a buyer.

### BRIEF DESCRIPTION OF THE DRAWING FIGURES

FIG. 1 is an exemplary flow diagram of the process used in a preferred embodiment of the present invention to match buyers and sellers for goods and/or services based upon the specification of Parameters.

FIG. 2 is an exemplary flow diagram of the process shown in FIG. 1, wherein the process steps of defining Parameters, matching buyers and sellers, through the step of generating a contract is depicted for the preferred embodiment of the present invention.

FIGS. 3A-3C are a more detailed flow diagram showing the process of FIG. 2 in finer detail for the preferred embodiment of the present invention.

FIG. 4 provides a schematic representation of a system for implementing the process of the present invention.

FIG. 5 represents a logic flow diagram of the method of providing Profile links according to an embodiment of the present invention.

FIG. 6 is a block schematic diagram of one embodiment of a system implementing the Profile link system of the present invention.

FIG. 7 is an exemplary screen shot of a main menu page for an Internet based embodiment of the present invention.

FIG. 8 is an exemplary screen shot of a User profile page for an Internet based embodiment of the present invention.

FIG. 9 is an exemplary screen shot of a Bid Request Summary page for an Internet based embodiment of the present invention.

FIG. 10A is an exemplary screen shot of a New Bid Request page for an Internet based embodiment of the present invention.

FIG. 10B is an exemplary screen shot of a Project Details page for an Internet based embodiment of the present invention.

FIG. 10C is an exemplary screen shot of a Project Users page for an Internet based embodiment of the present invention.

FIG. 10D is an exemplary screen shot of a Request Manager page for an Internet based embodiment of the present invention.

FIG. 10E is an exemplary screen shot of a Request Details page which includes a Profile link for an Internet based embodiment of the present invention.

FIG. 10F is an exemplary screen shot of a Package page for an Internet based embodiment of the present invention.

FIG. 11 is an exemplary screen shot of a Closed Bid Request page for an Internet based embodiment of the present invention.

FIG. 12A is an exemplary screen shot of a Replies to Bid Request page for an Internet based embodiment of the present invention.

FIG. 12B is an exemplary screen shot of a Vendor Info page for an Internet based embodiment of the present invention.

FIG. 12C is an exemplary screen shot of a Vendor Feedback page for an Internet based embodiment of the present invention.

FIG. 13 is an exemplary screen shot of an All Projects page for an Internet based embodiment of the present invention.

FIG. 14A is an exemplary screen shot of an On-Shore Project Details page for an Internet based embodiment of the present invention.

FIG. 14B is an exemplary screen shot of a second On-Shore Project Details page for an Internet based embodiment of the present invention.

FIG. 14C is an exemplary screen shot of a Well Definition page for an Internet based embodiment of the present invention.

FIG. 14D is an exemplary screen shot of a Well Summary page for an Internet based embodiment of the present invention.

FIG. 14E is an exemplary screen shot of a Hole Section Details page for an Internet based embodiment of the present invention.

FIG. 14F is an exemplary screen shot of a Well Summary page for an Internet based embodiment of the present invention.

FIG. 14G is an exemplary screen shot of an On-Shore Geological Prognosis page for an Internet based embodiment of the present invention.

FIG. 15A is an exemplary screen shot of a Primary Cementing Request page for an Internet based embodiment of the present invention.

FIG. 15B is a continuation of the exemplary screen shot of the Primary Cementing Request page of FIG. 15A for an Internet based embodiment of the present invention.

FIG. 15C is a continuation of the exemplary screen shot of the Primary Cementing Request page of FIGS. 15A and 15B for an Internet based embodiment of the present invention.

FIG. 15D is a continuation of the exemplary screen shot of the Primary Cementing Request page of FIGS. 15A, 15B, and 15C for an Internet based embodiment of the present invention.

FIG. 15E is an exemplary screen shot of a blank Bid Pricing page in response to a primary cementing request for an Internet based embodiment of the present invention.

FIG. 15F is an exemplary screen shot of a populated Bid Pricing page in response to a primary cementing request for an Internet based embodiment of the present invention.

FIG. 15G is an exemplary screen shot of a Detailed Bid Pricing page in response to a primary cementing request for an Internet based embodiment of the present invention.

FIG. 15H is a continuation of the exemplary screen shot of the Detailed Bid Pricing page in response to a primary cementing request of FIG. 15G for an Internet based embodiment of the present invention.

FIG. 16A is an exemplary screen shot of a Request Manager page for an Internet based embodiment of the present invention.

FIG. 16B is an exemplary screen shot of the Bid Pricing page for a primary cementing job received by a buyer using an Internet based embodiment of the present invention.

FIG. 17A is an exemplary screen shot of a Calendar page depicting the starting dates for a group of wells in an example for an Internet based embodiment of the present invention.

FIG. 17B is an exemplary screen shot of a Calendar page depicting the relevant dates for a bids used in an example for an Internet based embodiment of the present invention.

FIG. 18 is an exemplary screen shot of a Request In-Box page for an Internet based embodiment of the present invention.

### DETAILED DESCRIPTION OF THE INVENTION

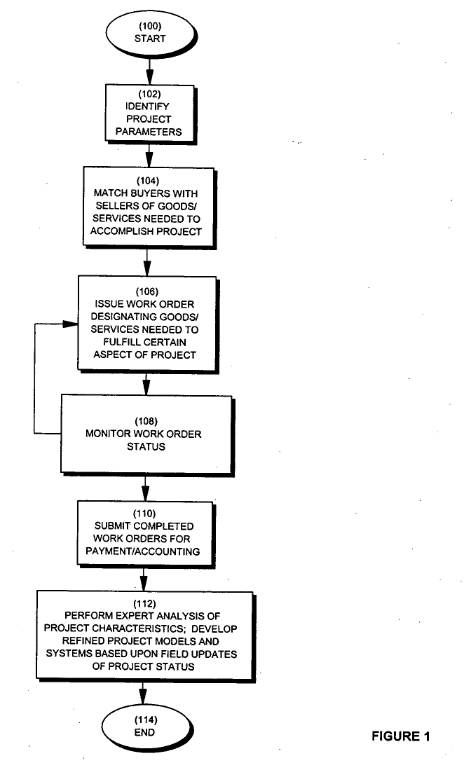

FIG. 1 provides an overview of a preferred embodiment of the process the present invention. As shown, the process of the present invention generally provides the functions of allowing a buyer to identify a project in terms of project Parameters (Block 102). These Parameters are then utilized, by a system implementing the process, to generate requests for the provision of goods/services needed to accomplish the project and match buyers with sellers of such goods/services (Block 104). Preferably the requests are received by at least one seller who then provides a response specifying the terms and conditions under which the seller is willing to provide the requested goods/services or alternatives thereto. Depending upon the amount of variation between the request and proposal, and other factors, the process preferably continues with negotiations occurring between the buyer and at least one seller until the necessary terms are agreed upon and a matching of a buyer with a seller is accomplished.

Upon matching such buyers and sellers, the process provides the capability of entering into contracts between the buyers and sellers for the provisioning of the needed goods/services. Additionally, the process provides for continued monitoring of the progress of the project by utilizing work orders (Block 106). The work orders preferably provide an electronic task sheet which is utilized by sellers to identify tasks/goods to be provided and the status of such tasks/goods. Automated monitoring capabilities for the work orders are also provided (Block 108). Such monitoring features enable the process and users of the process to stay abreast of developments and the status of a project.

Upon completing a work order, the process provides for the person accomplishing or responsible for the work order to submit an updated work order which details activities performed, costs incurred, and other information (especially accounting and billing information). Such information may be utilized by automated billing systems and other back-end functions (Block 110). Additionally, the process provides the capabilities of using knowledge management systems to identify project trends, recommend solutions or changes to project Parameters, provide a basis for future project planning, and perform various other expert based functions (Block 112).

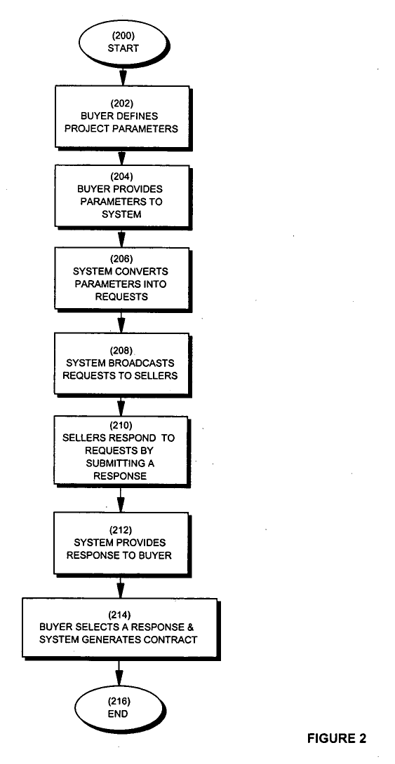

FIG. 2 provides an overview of the processes utilized to identify a project in terms of Parameters, generate requests by buyers, and receive responses from sellers to such requests. As shown, the process preferably begins when a buyer specifies a Parameter for a project (Block 202). These project Parameters may be as simple or as complex as a particular project requires. Additionally, the project Parameters may include Parameters, which were previously specified for similar projects, that are imported into the new project's definition fields. The specifications provided for a given project are preferably defined in terms of Parameters. However, the process accommodates any specifications and any Parameters.

The process also accommodates various methods of defining project Parameters. In one embodiment, project Parameters are specified using a plurality of inputs to prompts provided by the process. In other embodiments, project Parameters are provided to the process by transferring files generated via other processes. For example, the process of designing a building may be as simple as importing a building design on a Computed Aided Design/Computer Aided Manufacturing (CAD/CAM) system, or as complex as entering every building specification into a system implementing the process.

In the preferred embodiment, the system suitably enables a buyer (whether tae buyer is, for example, an engineer, an architect, a computer programmer, or even a non-technical person) to define a project in generic terms without having to specify the precise quantities, qualities, time constraints, and other variables commonly utilized when defining a project. That is, the present invention enables a buyer to specify, for example, an oil well drilling project in geological terms without having to specify a particular type of well casing or a type of drilling fluid to be utilized.

Once the project Parameters have been identified, they are preferably entered into a system implementing the present invention (Block 204). The system then preferaby determines whether the project meets the appropriate building codes, quality control standards, business rules, and any other requirements and/or specifications required by law, code, regulations, standards, preferred methods, etc. Such laws, codes, regulations, standards, and preferred methods, for example, are well known in the art, and are not discussed nor identified herein.

When a project clears the aforementioned checks, the process preferably converts the Parameters into requests for goods/services (Block 206). When converting the Parameters into requests, the process utilizes expert systems, including artificial intelligence modules, rule based processes, matching processes, classification processes, and various other processes or combinations of processes, as necessary, to generate requests for the provision of specific goods/services. As may be appreciated by one skilled in the art, the systems and processes necessary to convert a Parameters defining a project into at least one request may vary significantly based upon the project, the Parameters, and/or the goods/services needed. The present invention accommodates such variations by providing a process which may utilize other processes, as necessary, to perform such conversions. Additionally, it is to be appreciated that a project may generate hundreds of requests for goods/services. All such requests are preferably generated and supported by a system implementing the present invention. However, the process may also utilize Parameters provided by external systems (for example, via a network connection, floppy disk, CD, or similar device).

Additionally, each request preferably includes those terms and conditions commonly associated with a particular project or type of project. Such terms and conditions may be provided, for example, on templates, data entry charts, and other devices used to generate requests for goods/services. Buyer requests, for example, may be requests for proposals, requests for bids, requests for estimates, requests for feedback, or requests for current contract pricing. However, the process may also suitably accommodate various other types as requests, as desired.

Upon generating a request for goods/services, the request is preferably transmitted to the sellers (Block 208). The process then continues with a dialogue between the buyer and seller. In order to facilitate the dialogue and reach a common understanding on the scope and terms of the request, when necessary, the process preferably allows both the buyer and the seller to access documents provided via a centralized location and/or over a network connection. Such documents may include the project Parameters, suggestions from sellers about how to accomplish a given task, bids on goods/services, and similar information. By utilizing appropriate security systems, the process enables real-time interactive dialogues to occur between a buyer and a seller via any system, format, or protocol which facilitates the communications of such requests to sellers and responses to buyers.

Additionally, the process provides for notifying sellers that a request is available by utilizing any available forms of communication including, but not limited to, e-mail, postings on Internet sites, telephone messages, pager messages, facsimile, and mail. Additionally, the process enables the buyer to determine to whom and when requests are communicated. For example, a request may be designated for communication to specific sellers identified on the buyer's preferred seller listing. Similarly, the requests may be communicated to any seller providing the requested goods/services. Such sellers may be identified in centralized data records, via searches of the Internet, or in other databases. In short, the present invention accommodates the communication of requests and/or responses to as few or as many sellers, buyers, or others, as desired, by the originator of the communication.

Upon receiving requests, sellers may respond in a variety of ways (Step 210). Responses by sellers may include, for example, offers to provide the requested goods/services, offers to provide substitute goods/services, and proposals of alternative solutions. In short, any type of response by sellers may be accommodated by the present invention. As is further understood by those skilled in the art, responses by sellers may be processed by any system including Internet based systems, telephone message systems, and e-mail systems. In the preferred embodiment, as mentioned previously, responses by sellers are provided real-time to buyers by utilizing a system which permits both buyers and sellers to access a database containing the project Parameters, requests, and seller responses. Therefore, any manner of communicating a response by a seller to a buyer is considered to be within the scope of the present invention.

Once a response is received from a seller, the process preferably provides the response to the buyer in real-time (Step 212). As in the case of communicating requests to sellers, the process may utilize any manner of communicating responses from sellers to buyers and/or notifying buyers and sellers that requests, responses, updates, or any other communications are available for their review. Additionally, as desired, the process may manipulate such responses such that they are in a form specified by a buyer, a seller, and/or a system implementing the process. Thus, the process may convert a response into a legally binding offer, into an engineering specification, or any other format specified by the buyer or seller. The process may also be configured to display side-by-side a buyer's requests with at least one seller's response and preferably with multiple sellers' responses. In this manner, the buyer may review and compare responses simultaneously without having to access numerous databases and/or files.

Upon communicating the response to the buyer, the process preferably continues to facilitate negotiations between the buyer and at least one seller, when desired. When the buyer and seller have agreed upon the terms provided in a response or a counter-response (i.e., a rebuttal provided by the buyer to the seller), the process preferably establishes an on-line electronic contract between the buyer and seller for the provision of the bargained for goods/services. It is to be appreciated that the original request and the seller's response may undergo numerous iterations and modifications before a final agreement between the parties is reached. The present invention suitably accommodates such iterative processes by providing the necessary data archiving and storage functions.

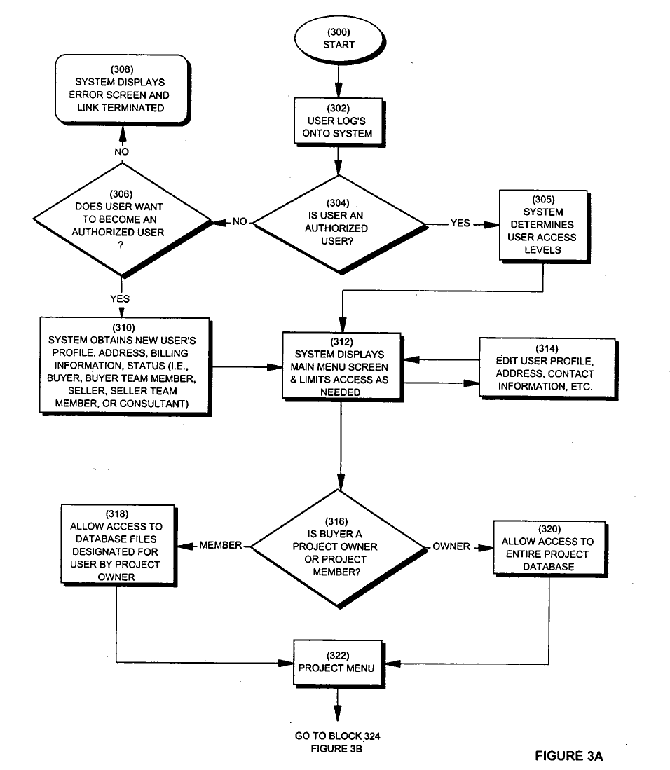

Since delays, rescheduling, and substitutions of goods/services often occur when undertaking a complex project (for example, drilling an oil well), the process also provides for the adaptation of contractual terms, as necessary, by allowing both parties (the buyer and seller) to monitor the progress of the project at any time via a common database. These project monitoring features enable buyers and sellers to more precisely determine when specific goods/services will actually be needed without having to engage in repeated attempts to contact each other via telephone, fax, e-mail, or other mediums. As is appreciated in the art, for some projects, establishing lines of communications between numerous parties is often impossible, impractical, and financially prohibitive. For example, when drilling for oil in Greenland it is often very difficult to establish reliable and continuous communication links with the rest of the world. Instead of being required to contact numerous sellers about construction delays or accelerations, the process of the present invention enables a buyer or a buyer's team member (for example, a rig foreman) to simply log onto a database containing the project's Parameters and provide an updated status to all interested parties (preferably via a network linked to the database). Such interested parties may include the seller providing the pumping rig, the accountants with the oil company, the drilling engineer monitoring the progress of the well from Texas, and others. Thus, the present invention facilitates continued project monitoring after a contract has been formed between a buyer and a seller for the provision of goods/services. Additionally, by maintaining on-line databases, the process facilitates the archiving of projects, requests, proposals, and other information. The archived information may then be utilized to further the processes by which project Parameters are converted into requests and buyers and sellers are matched. FIGS. 3A-3C illustrate another embodiment of the process by which the present invention facilitates the generation of requests and responses, and the formation of contracts for goods/service between a buyer and at least one seller. As shown for this embodiment, the process preferably begins when a user logs onto a system implementing the process (Block 302). Upon logging onto a system implementing the process, the process verifies the user is either a project owner (i.e., a buyer), a member of a buyer's team, a seller, or a member of a seller's team by requesting an appropriate user identifier (Step 304). The process allows a buyer to designate members of a team working on the specific project while also allowing sellers to designate their team members. Further, a buyer may limit access to information associated with a project to specific buyer's team members and sellers. Additionally, the buyer may deny certain buyer's team members permission to submit requests, reply to responses, or to perform various other tasks. Similarly, a seller may limit the authority, access, and capabilities of seller's team members. In this manner, the process allows buyers and sellers to set the desired levels of security required to access specific features and information provided by the process.

Additionally, as is commonly known in the art, verifications of user identities may be accomplished in a variety of manners including sign-ons and passwords, determinations of originating locations (i.e., from where the link is being established), bio-identifiers (i.e., fingerprints, retinal scans, and voice prints), and via various other techniques. The process may utilize any system for verifying a user's identity, but, in the preferred embodiment, such verifications are accomplished via a sign-on name and password. Thus, it is to be appreciated that like any publicly networked system, initial access to a server providing the system may be obtained by any person on the network. However, access to specific data files, features and functions of the present invention are limited to authorized users, as specified by the buyers and sellers.

Referring again to FIG. 3A, when a new user or an unauthorized user logs onto a system implementing the process, a query is issued as to whether the user desires to become an authorized user (Block 306). If the user does not desire to become an authorized user, the process terminates and an error screen is preferably displayed (Block 308). In this manner, the process prevents unauthorized users from tying up the system or the network connections.

When a new user desires to become an authorized user, the process preferably continues with obtaining information from the user (Block 310). The information obtained may include, for example, a user profile which includes a name, address, phone numbers, bank accounts, billing information, and other information necessary to engage in electronic commerce. The information obtained also includes an identification of whether the user is to be a buyer, a buyer's team member, a seller, or a seller's team member. When the user desires to be a buyer or a seller, the process preferably includes a verification of the user's credentials. The verification step may be accomplished automatically (for example, by searching a directory of suppliers in a particular industry sector), or manually (for example, by having a customer support specialist verify via phone, fax, writing, or other sources a user's identity). In this manner, the process preferably limits misrepresentations of buyers and/or sellers.

Similarly, when the user desires to become an authorized buyer's team member (for example, a drilling engineer assigned to a buyer's team), or a seller's team member, appropriate verifications are made with database files established by the buyer or seller, as appropriate, for identifying team members. Additionally, the process also may issue telephone, fax, e-mail, or direct data inquiries to a buyer or seller seeking authorization to add the new user to their respective teams. Similarly, when a buyer or seller establishes a team, preferably the buyer or seller specifies the level and type of access each team member is to have. For example, a geologist on a buyer's team may have access to templates providing geological information, but is not allowed access to processes which submit requests, accept proposals, or other functions. In this manner, the present invention provides a system and process which enables a buyer/seller to limit and provide access to a centralized project database for any team member, regardless of location, while also preventing access to the information and features of the process by an unauthorized user.

When an authorized user accesses a system implementing the present invention, the process also allows the user to edit their profile information, profile information for a team (for example, adding or deleting users from a project team), and perform various other administrative tasks (Block 314). Additionally, once the user has gained access, the process preferably continues to provide access to files as determined by the user's status (Blocks 316, 318, and 320). One manner in which access to files and features of the present invention is provided is preferably via a main project menu (Block 322). The main project menu preferably provides a user who happens to be a buyer with various options such as viewing a list of existing projects (Block 324), creating new projects (Block 326), and selecting an existing project (Block 328). Similar options are also provided for sellers, as further described herein. However, various other features may also be provided at this stage of the process, as desired, depending upon the user's authorizations and access. Such features, for example, may include reviewing new requests for proposals (when the user is a seller or a seller's team member), reviewing responses to requests (when the user is a buyer or buyer's team member) and reviewing updates to requests. In short, the process may be modified as desired to allow access to the various features and functions of the process at any time, as desired, and is not limited to a specific process flow.

When the view project list feature is selected (Block 324), the process preferably allows a buyer (or, a buyer's team member) to select various categories of projects including, but not limited to, pending projects, completed projects, deleted projects, archived projects, and projects within specific date ranges, territories, or based upon any other Parameter. The process preferably provides for the storage of project information on permanent storage devices (for example, CD-ROMS, hard disk drives, network servers, and disk packs) accessible from any location capable of establishing a network connection (for example, via an Internet connection over a satellite phone). The process also facilitates the updating of projects and the copying of projects or project aspects (which may be useful, for example, in building tract houses, drilling multiple wells in a specific area, or repetitive activities). Thus, the process enables a user to access data quickly as needed, and to utilize such data in specifying new projects, revising requests, modifying requests, and various other tasks. Additionally, the process may be configured to automatically populate data applicable to multiple projects or aspects of a project. Such data may include, for example, billing information, contact information, legal descriptions, special terms and conditions, and any other information. In this manner, the process of generating requests may be as streamlined as desired.

When a buyer desires to create a new project, the process preferably queries the buyer as to whether any aspects of the project should be transferred or copied from a pre-existing file (Block 330). This could be either a pre-existing project file resident on a system implementing the process, or a file wholly separate from the system. For example, a building specification may be designed on specialized architectural software which is transferred as a data file to a system implementing the process and subsequently converted into the appropriate format (Block 332). Similarly, in an oil drilling application, geological data on a well design might be imported from a geology application software program and converted by the process into the appropriate Parameters. Those skilled in the art appreciate that various software modules may be utilized in conjunction with the present invention to convert data files of a first type into a data file compatible with the process of the present invention.

Upon completing a transfer of a file into a format compatible with the process, or when a file transfer is not desired, the process preferably continues with the buyer or buyer's team member inputting and/or editing Parameters which describe the project (Block 334). Depending upon the complexity of the project, numerous Parameters may be needed to describe a project or, for example, in the case of a simple product purchase, only a few Parameters may be needed. The process preferably provides templates and other data entry fields (which may be selected, for example, via pull-down menus) to assist the buyer or buyer's team member in entering and/or specifying the appropriate Parameters. The templates preferably request a buyer to provide those terms and conditions (i.e., the Parameters) necessary to describe the project, while not requiring the buyer to actually specify a specific quantity or a need for a particular good or service. As such, the templates may assist a buyer in completely defining a project by providing data fields requesting specific information essential to defining the project. For example, an oil drilling project may include a template which provides data fields for entering a well hole depth, a location, and a date. The remainder of the terms (for example, the fact that a particular drilling rig may be needed because of the desired well depth or location) are preferably determined automatically by the process based upon the buyer's inputs.

Similarly, the process also allows a buyer to specify commodities (i.e., specific goods/services) without identifying a complete project or project specifications. For example, a drilling engineer may need only 10,000 feet of well casing. Instead of specifying a project and well for such casing, the system allows the engineer to request the specific goods/services needed, where they are to be delivered, and when they are needed. The remaining Parameters needed for such a project (for example, arranging transportation for the casing to the well) are preferably determined by the process (either automatically or in conjunction with a buyer's inputs). In short, the process allows a buyer to define a project in general terms, with additional specifications provided either automatically or upon prompting on detail sheets and templates generated by the process. Those skilled in the art appreciate the fact that the level of detail often is inversely proportional to the level of expert and/or rule based processing available to convert the Parameters into specific requests for goods/services. As such, the present invention may be tailored to any desired level of expertise (for example, a master, apprentice, or novice level). Additionally, the process may be configured to recognize that a specific buyer may need additional prompts or assistance, as demonstrated by a buyer experience rating. Additionally, to facilitate the generation of requests, the process preferably gears each detail sheet to the needs of the buyers in light of the available technology. In this manner, the process enables buyers to enter as little detail as possible, if so desired, while the system “fills in the blanks” and provides the remaining details necessary to prepare a request by accessing the appropriate program modules, expert systems, and other rule based processes. The process is also, preferably, routinely updated to take into consideration new products, techniques, and methods for accomplishing a given task. Such updates may be automatically generated by the present invention or suitably accessed from other systems via a network, such as the Internet, or other communications systems.

Once the Parameters for the project have been provided, the process preferably continues with verifying that the Parameters comply with the appropriate design rules (Block 336). The design rules are preferably provided as elements of a process provided for an industry specific application. For example, design rules specific to the construction industry may specify conditions such as the type of reinforcement utilized in a foundation supporting a given story building, or the grade of wiring needed to provide a dryer circuit. Additionally, generalized design rules, which are applicable to a wide variety of industries and/or projects, may also be utilized by the process. Such generalized design rules may include, for example, ensuring compliance with environmental rules and regulations, OSHA rules and regulations, and other information applicable to a project.

As may be appreciated, various types of design rules may be utilized to verify Parameters. These design rules include, but are not limited to: comparisons (for example, verifying the dimensions of a window frame are larger than the window itself); relative relationships (for example, window #1 is 90% larger than window #2); algorithmic (for example, whether a building lot size minus the footprint of the building is greater than zero); complex algorithmic relationships; external rules; membership based rules; case based rules; and expert system based rules (for example, the process evaluates the data, determines the likely purpose, and is able to verify correctness).

When the Parameters do not comply with the various design rules, the process suggests changes to the Parameters (Block 338). The changes suggested vary depending upon various factors including the project at issue, the Parameters already entered, and the design rules. The process provides the design change recommendations to the buyer, which the buyer may add, delete and/or modify. The process preferably records the recommendations, additions, modifications, and deletions of each Parameter for subsequent use by knowledge systems when attempting to streamline the matching process.

After the buyer has provided a set of Parameters (which preferably have been verified by the system) the process continues with either saving the Parameters for future use or categorizing the Parameters into at least one request for a good or service (Block 340). As may be appreciated, for complex projects, such as drilling an oil well, the Parameters may be reviewed and modified by numerous geologists, engineers, rig operators, and others prior to the generation of actual requests for goods/services (Block 342). Additionally, a buyer may desire to develop the Parameters for a project and save such Parameters for future use after regulatory or other approvals have been acquired. As such, the process preferably provides a mechanism by which the user may save project Parameters without having to produce requests for goods/services. At this stage, the process preferably ends or is temporarily delayed until new Parameters are provided or a request is generated based upon the Parameters (Block 344).

When the buyer desires to have the Parameters converted into requests for goods/services, the process preferably continues with examining each Parameter (as provided in a template or data entry field) and identifying different classifications of goods/services needed to satisfy each Parameter (Block 346). The process preferably makes such identifications by utilizing pre-defined classifications of goods (for example, casing, wiring, and lumber) and services (for example, cementing, framing, and plumbing). When Parameters exist for which a classification does not exist, the process preferably generates unique classifications reflective thereof. These unique classifications are preferably selected by the buyer for transmission to select sellers providing similar goods/services, but may also be provided to any seller, as desired by the buyer.

Additionally, in an alternative embodiment, the process may also include searches of other projects for the buyer in order to determine whether economies of scale may be obtained by combining requests from numerous projects into one request (Block 348). For example, the purchase of 2×4 boards may be less expensive by the truckload than by the half truckload and by combining two housing project requests into one request, a truckload of lumber may be requested and savings realized. Similarly, a user may also authorize the process to combine requests based upon geographic or other considerations. Thus, the process may be configured to obtain any desired economies of scale in the procurement of goods/services by associating Parameters with classifications of goods/services.

After identifying classifications of goods/services and grouping such goods/services together, the process preferably determines whether a first grouping depends upon a second grouping for information (Block 350). For example, the system might determine that a drill bit grouping depends upon casing information in order to know which type and/or diameter of drill bit to request. The process also examines whether descriptions of goods/services exist for the groupings identified. For example, a drilling engineer might request specialized equipment for which goods/services classifications do not exist. In such instances, the process preferably creates an error report which may be utilized to identify new groupings and sellers of goods/services fulfilling each such grouping. Additionally, the process preferably converts groupings of goods/services into specific goods/services descriptions which correlate to goods/services descriptions being offered by a seller in a geographic area. In this manner, both the buyer and seller are in concurrence as to which goods/services are fulfilled by specific descriptions.

In addition to converting Parameters into requests, the process may also be configured to attach conditions, documentation, terms, and other information into identifications of goods/services (Block 352). These conditions may include, for example, warranty provisions, payment terms, and delivery terms.

At this point, the process preferably searches at least one database containing a listing of sellers providing the goods/services identified in the groupings (Block 354). Such databases and files may include preferred seller lists, non-approved seller lists, and other information necessary for determining to which sellers a request for the identified goods/services should be made. Further, the process may also be configured such that buyers search only for pre-approved sellers of goods/services. In some industries, for example oil and gas, buyers often desire to enter into agreements only with proven sellers. Similarly, some sellers may desire not to be identified as providing goods/services to some buyers (for example, due to a past history of poor payment). The process also interrogates any additional databases and files, as necessary, to determine whether specific sellers should receive a request from a specific buyer.

In order to accomplish the searches for sellers, preferably each seller has pre-registered with a system implementing the process. When registering, each seller suitably identifies the classifications of goods/services they provide and any specific terms or conditions for such goods/services (for example, delivery and payment options). Sellers may adjust the goods/services they provide, or are designated as providing, at any time. Additionally, the process may search databases (for example, the yellow pages), the Internet, and other resources, as desired, to identify sellers of specific classifications of goods/services, even if the seller is not registered with a system implementing the process.

Upon identifying those sellers which provide the needed goods/services, the process preferably continues with the buyer designating sellers to whom the requests are to be transmitted (Block 356). While the process preferably transmits requests only to the selected sellers, it is to be understood that buyers may select as many sellers as desired to receive requests (even sellers that do not provide the requested goods/services). The process also allows buyers to utilize a preferred sellers list (or similar pre-identification of those sellers with whom the buyer desires to conduct business). When a preferred sellers list exists, the process preferably limits communication of such requests to only the preferred sellers. The process also facilitates the anonymous requesting of goods/services by masking a buyer's identity or using other confidentiality and security features such as secure socket layers, encryption schemes, and dedicated networks.

Once the buyer has identified those sellers to whom the requests are to be communicated, the process preferably allows the identified sellers to access the request (Block 358). Additionally, the process provides a notification to each identified seller that a new request is outstanding. Such notifications are preferably made utilizing, when available, a notification scheme pre-designated by the seller. For example, some sellers may prefer to be notified via a pager, while other sellers may prefer an e-mail message. The process of the present invention accommodates these and other commonly known methods for notifying a seller.

Upon receiving and reviewing a request, sellers may either offer a response to the buyer, recommend alternatives to the request, make proposals, or ignore the request. Since the request is merely a solicitation for offers and is not an offer itself, the process does not create any binding obligations until a response containing a binding offer is received from a seller and is accepted by the buyer. Additionally, when the seller responds to the buyer's request, the process allows a seller to modify terms and conditions of the request, recommend changes, or provide other communications to the buyer, via the shared common database. However, the process may also be configured such that a seller's access to a database containing the request may be limited to only reviewing the request and then either accepting or not accepting the request. Regardless of the level of access provided to a seller for any request, the process preferably maintains copies of the original request, responses, and subsequent communications between the buyer and seller, thereby providing a record of the negotiations between a buyer and a seller. Further, the process preferably allows the buyer access to all the responses from the various sellers, while prohibiting access by a first seller to a second seller's response, and vice versa. In this manner, collusion, price fixing, and various other undesirable practices are discouraged, since each seller is not aware of to whom a given request has been submitted or the responses by the various sellers receiving a request. However, the process may also be suitably configured such that an open bidding process is provided wherein each identified seller may review the request, responses from other sellers, comments, and offers.

Upon receiving a response from a seller and before the process provides the seller's response to the buyer, the process preferably determines whether the seller has recommended an alternative solution to the request or changed any of the material terms of the request. (Block 362) Further, the process screens responses and identifies to the buyer those terms in a response which vary from the terms of the request. The process may accomplish such identifications by highlighting the changed terms, providing a warning notice to the buyer when the buyer opens the response, or by any other notification means. However, the process may also be configured such that determinations of changed terms and identifications thereof are not provided, when so desired.

Additionally, the process preferably verifies whether the response complies with the design rules established for a given task (Block 364). For example, a response changing a particular gauge of wiring selected for a given task might be upgraded to a lower gauge or downgraded to higher gauge by a seller. If the changed gauge provides the necessary load carrying capacity for the given circuit, as in the case of a lower gauge, then the process preferably accepts the design change. However, if the changed gauge does not provide the necessary load carrying capacity, then the process preferably notifies the seller of the deficiency and allows the seller to change the response or to not change the response, while highlighting the discrepancies to the buyer (Block 366). Preferably, the process verifies the seller's response when it is submitted. However, the process may be configured to verify a seller's response at any time, for example, during the formulation of the response, or at a later time (for example, when a new regulation comes into effect which may impact the response). Therefore, the process preferably applies the same business rules and design verifications to each seller's response as it applies to each buyer's request. In this manner, both sellers and buyers are assured to a given level of certainty that a request, and response is acceptable and in compliance with the appropriate business and other rules. However, the process may also be configured, as desired, such that the design rules and other preferred verifications of a seller's response are not conducted and/or provided.

Further, when a seller's response does contain terms or Parameters which have been identified by the process as not being in compliance with a given rule, the process preferably utilizes expert and knowledge based systems to suggest changes to the seller's response (Block 368). For example, an expert based system for electrical projects may recommend that a lower gauge of wiring or a modified circuit design is needed in order for the response to comply with a given set of electrical codes, for example, a set of codes accessible via a network connection such as the Internet. The seller may then accept the recommended changes, provide other changes, or deny all changes and submit the response (Block 370). At this point, the process again verifies whether the response complies with the design rules (Block 364) and the process continues with verifications and/or design changes until either the response complies, or the seller indicates that the response will not include any more changes and that it is to be presented to the buyer as specified. At this point, the response is available for the buyer to review and a notification that the response is available is preferably sent to the buyer (Block 372). As is to be appreciated by those skilled in the art, the process of verifying a response and multiple revisions to a response may be accomplished as many times as is necessary and desirable. For highly complex operations, such as building an airplane, in which numerous variables, factors, and design rules may come into play, the request/response review process may be quite extensive. The present invention preferably accelerates such design review processes. For example, changing a seat configuration on an airplane may impact systems such as electrical, environmental, weight distributions, and numerous others. As such, the process preferably automates as many design rules as possible, thereby simplifying the conversion of design Parameters into requests for goods/services and the verification of responses thereto.

Upon a buyer being provided with a response, the process preferably continues with the buyer reviewing the response, accepting the response, deleting the response (with or without reviewing the response, for example, when the buyer has already accepted another seller's response), or entering into negotiations with the seller providing the response (Block 374). Depending upon the buyer's reaction to the response, the process may be continued at practically any step along the before mentioned process flow. More specifically, it is to be appreciated that in a scenario where no seller provides a response, the buyer may be forced to reconsider the project, change terms of the project, identify additional sellers, or perform various other actions. Similarly, in the case where a seller's response suggests changes to the request that the buyer may not have considered, the request may be suitably modified by the buyer and then resubmitted to all sellers, select sellers, or even only to the seller recommending the changes. As such, the actions accomplished by the buyer upon receiving a response may be varied and widespread and can not be accurately captured in a simple flow diagram. The present invention provides a process with sufficient flexibility such that a buyer or a seller may accomplish any process step at any time, when feasible.

Preferably, the buyer and at least one seller eventually agree upon a response which fulfills the buyer's needs. When this occurs, the buyer and seller preferably elect to enter into an agreement, utilizing the terms supplied in the final negotiated response. The process facilitates those actions (commonly known in the art) necessary to enter into an agreement and provides the ancillary documentation, verifications, and other components needed in an agreement (Block 374). Additionally, for the preferred embodiment, the agreement is entered into electronically without the exchange of any paper based documentation or agreements between the buyer and seller. As such, the process preferably covers all aspects of designing a project, determining goods/services necessary to complete the project, and the entrance into at least one contract providing for such goods and services.

As is appreciated by those skilled in the art, the process described above may be implemented on any system, network architecture, configuration, device, machine, or apparatus, and is not to be construed as being limited to any specific configuration, network, or systems. The process may be suitably implemented on conventional computing devices, for example, computer workstations, on Internet based applications, on optical computing devices, neural computers, biological computers, molecular computing devices, and other devices. As may be appreciated by those skilled in the art, the present invention, in short, may be implemented on any system, automaton, and/or Turing machine. Similarly and more specifically, the Parameters specified by a buyer in a request (or a seller in a response) may include any Parameters necessary to adequately describe a buyer's needs and/or the goods/services which a seller can provide in response to such needs.

Also, the present invention is not limited to matching specific types of buyers with specific types of sellers. Any buyer may utilize the present invention, as desired, to acquire goods/services from any seller. For example, drilling engineers may utilize the process to obtain casing used in a well from both steel pipe and concrete pipe sellers. Similarly, a financier of an oil drilling project may acquire investors for the oil drilling project by providing project specifications to potential investors (sellers) who then offer to provide financial resources (services) to complete the project. As such, the present invention may be modified, as necessary, to match buyers and sellers for any goods and/or services regardless of industry, complexity, local, or any other consideration.

The present invention also provides a process which allows sellers to pre-identify themselves as providers of goods/services based upon categories and/or classifications of goods/services instead of identifying themselves based upon specific goods/services. Such identifications may include, for example, industry product codes. Similarly, the present invention may also be configured to facilitate the automated matching of buyers and sellers by searching the Internet and similar networks for sellers of goods/services when a general request is submitted by a buyer. Such features suitably expand the universe of potential sellers for a given request beyond those sellers pre-identified to the process—a feature which may be extremely valuable when rare goods/services are needed.

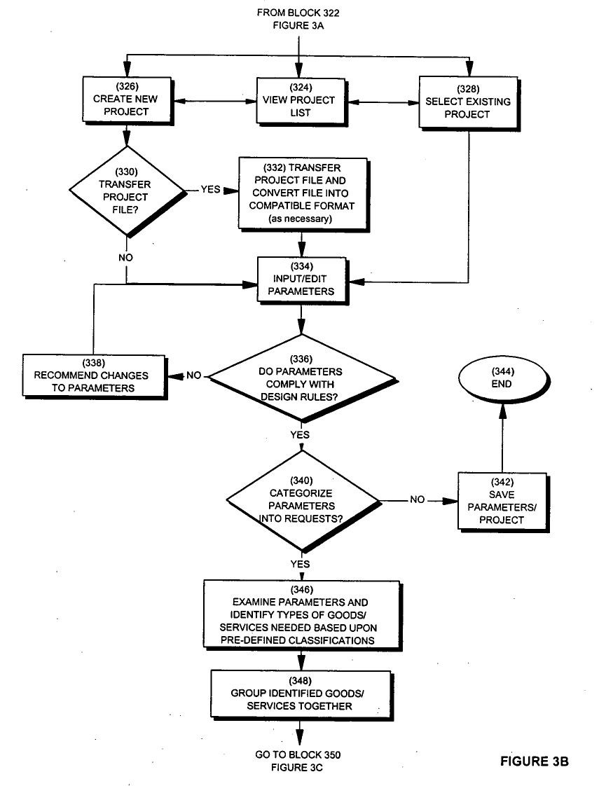

As shown in FIG. 4, the process of the present invention may be implemented by a system 400 for matching buyers 402 and sellers 404 of goods and/or services via a network 401. The network 401 may be any means of communicating a buyer's needs for goods and/or services (as reflected by Parameters associated with such goods/services) to sellers. The network 401 similarly facilitates the needs of sellers 404 to provide goods/services to buyers 402. A processing system 406 controls the interchange of information between buyers 402 and sellers 404 through the network 400, thereby ensuring an organized and controlled market is established and maintained for both buyers and sellers. The processing system 406 also preferably converts a buyer's needs into requests provided to sellers and facilitates all of the interactions between the buyers and sellers, and other processes identified herein. However, those skilled in the art appreciate that the features and functions of the buyer's system, the seller's system, and the processing system may be suitably combined or separated into any number of components and systems, as desired, without departing from the scope of the present invention. For example, the features and functions of the processing system, in an alternative embodiment, may be provided in part by the buyer's system while the remainder of the functions and features are provided by the seller's system. The present invention is not limited to any specific configuration, system, networks, or devices.

Additionally, the process of the present invention accommodates any type of network, system, method, or means of converting and communicating a buyer's needs for goods/services to at least one seller. The process of the present invention may be accomplished by any system which allows a buyer to specify Parameters which are then converted into requests for goods/services and communicated to sellers of such goods/services. Examples of such systems include, but are not limited to, telephony based networks (wherein Parameters are specified using telecommunication devices connected to the processing system 406), computer based networks (such as the Internet), optical networks, neural computing networks, and biological computing networks. It is to be appreciated, by those skilled in the relevant arts, that the process of the present invention may be accomplished in a multitude of configurations, systems, architectures, networks, and devices.

In an illustrative embodiment of the present invention (described in greater detail below), the process is accomplished via an Internet based system. The Internet provides the interfaces, the communications mediums, the software, databases, and expert systems, via at least one server, which are used by a buyer to communicate Parameters for a project, convert the Parameters into requests, and communicate the requests to a seller. A seller, upon receiving notification that a request is outstanding, utilizes a compatible device (for example, via a wireless device not connected to the Internet) to review requests, recommend alternatives, and submit bids—all via an Internet connection. Responses from sellers may then be verified by the Internet and/or transmitted to the buyer. Thus, in a preferred embodiment, a computerized network facilitates a buyer's specification of a project's Parameters, converts the project Parameters into requests for goods/services, and presents such request(s) to sellers providing the needed goods/services.

Further, as is commonly appreciated, the Internet based system may utilize various forms of communication including, for example, file transfers, e-mail, facsimile, audio communications, and video communications. Various other forms of communication, all of which are well known in the art, may also be utilized. As such, any and all forms of utilizing the Internet are considered to be within the scope of the present invention. Further, buyers and sellers may be connected to the Internet via various devices and systems including computer workstations, laptops, personal data assistants, pagers, wireless telecommunications devices, and other devices. The connection of such devices to the Internet is well known in the art.

The process of the present invention may also be implemented via a distributed Internet architecture in which a plurality of servers, each of which is accessible via the Internet, provide the processes described herein. Also, as is appreciated by those skilled in the art, other embodiments of the present invention may also be accomplished by various configurations of computerized and electronic systems and resources. Distributed network architectures, centralized architectures, Internet based systems, dial-up systems, wide area networks, and local area networks may all be used by the present invention, as needed, to facilitate communications.

In an alternative embodiment, the present invention facilitates the matching of sellers with buyers based upon Parameters specified by a seller. As can be readily appreciated, a process which matches buyers with sellers may be suitably modified to match sellers with buyers. Thus, for example, a seller desiring to reduce an inventory of raw materials used in making various grades of steel could submit a request seeking buyers of steel products. Such buyers could include those in various industries such as the automotive industry, aircraft industry, and even oil and gas industry. The process may be adapted to allow a seller to reach markets with which the seller is not generally associated. Therefore, the present invention provides a process for matching buyers with sellers, and sellers with buyers of goods and/or services based upon the specification of Parameters.

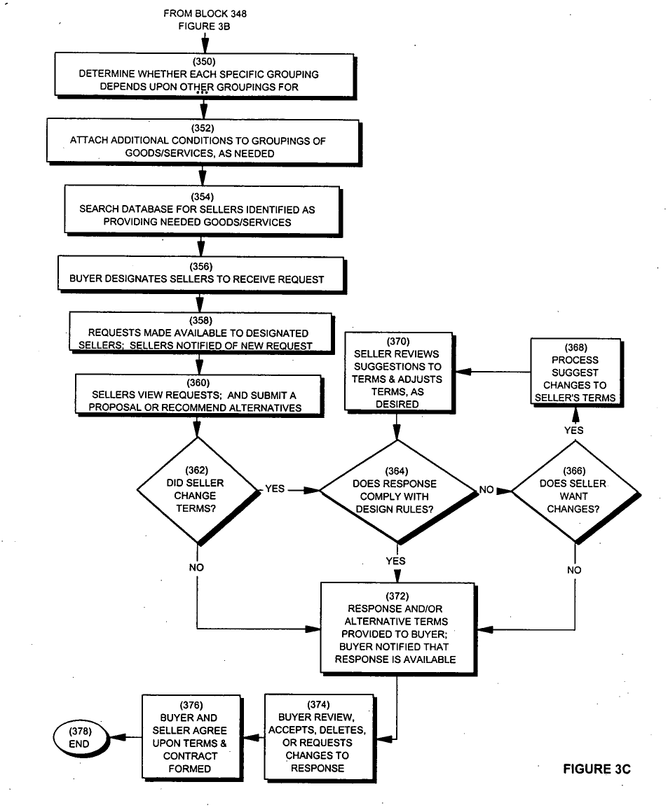

Additionally, the present invention facilitates targeted marketing of sellers' goods/services by utilizing Profile links. As shown in FIG. 5, the process by which the present invention provides the targeted marketing preferably begins when a buyer selects a template or data entry field on an system implementing the buyer and seller matching process of the present invention. However, while the Profile links are preferably utilized in conjunction with the above described process of matching buyer and sellers, it is to be appreciated that the Profile links may be utilized in conjunction with any system, process, or application which identifies a user based upon their current on-line activities. Additionally, for the purpose of the present discussion, the Profile links process is preferably implemented whenever a buyer accesses a screen on an Internet or Internet emulating process (i.e., a process which enables a user to jump from one data page to another upon selecting a link thereto).

As shown in FIG. 5, when the Profile links are provided in conjunction with the above described matching process, the Profile link process is preferably implemented whenever a user selects a template, data entry field, or function which has an associated Profile link (Block 502). At this point, the Profile link process suitably determines a profile for the buyer (Block 504). In the preferred embodiment, in which an Internet based web site and/or application is the medium by which a vendor advertises their goods/services to a user, the buyer profile information is obtained before the buyer accesses a page or template providing a Profile link. Preferably, the profile information is obtained when the buyer “signs-up” for the matching process of the present invention or another system implementing the Profile link process.

More specifically, when the buyer signs-up, the process queries the buyer about various topics and subjects. These queries may cover any topic which an operator of the process or a seller considers to be important. For example, when a general contractor signs up for the process, a query may be issued asking in which geographic areas the contractor generally constructs buildings. Based upon this information, a profile may then be established which indicates to suppliers of areas outside the buyers's general geographic area, that the buyer may not be a good target for their goods/services. However, the present invention is not limited to pre-set profiles or pre-set queries for determining a profile. The buyer's profile may be established by responses to inquiries, previous entries, buying habits, Internet access habits, specific needs, or other indicators. The buyer profile may also be established by the simple fact that the buyer has accessed a specific Internet site, web page, or application. Additionally, the process may be modified, as necessary, to accommodate the various goods/services, characteristics, needs, and preferences of buyers, sellers, and operators of any system implementing a Profile link.

Further, profiles may be created on a separate computer processor or on the buyer's or seller's computer workstation. As such, the profiles may be centrally generated and/or remotely generated. Profiles may also be packetized and distributed across the Internet, as desired. Those skilled in the art appreciate the various methods, systems, and configurations by which profiles of users and/or vendors may be created, stored, shared and manipulated via the Internet. Therefore, the present invention is not to be limited to any method or system for determining, providing, or using a profile. Any method which provides sufficient information to establish such profiles (to whatever degree of precision) may be utilized by the present invention.

Upon determining a user's profile (i.e., a buyer's profile or a seller's profile), the process preferably screens any previously entered or established profiles and determines which profiles “best fit” a buyer based upon a buyer's current activities, the Internet site selected, and/or the application being utilized by the buyer (Block 506). The “best fit” screening process may consider factors such as location, previous requests for goods/services, and past history with specific sellers (i.e., does the buyer have a history of using the seller's goods/services). The “best fit” screening process may also consider whether the buyer has specifically identified a seller as a preferred vendor. However, the process is not limited to any specific screening tests, or conditions and may utilize any factor to identify those sellers whose goods/services “best fit” a buyer's current needs.

Once sellers have been screened and those with the “best fit” identified, the process suitably displays such information on the appropriate screens or templates. The profile link information may be displayed in any portion of a screen display, for example, in the location of a screen wherein a banner advertisement is often displayed. Similarly, the profile link information may be displayed in any manner, at any location on an Internet screen display. Those skilled in the art realize the various locations, configurations, and mechanisms by which a profile link may be presented to a buyer. As such, the present invention is not to be construed as being limited to merely replacing banner advertisements with Profile links and may include any manner of providing such Profile links to a buyer.

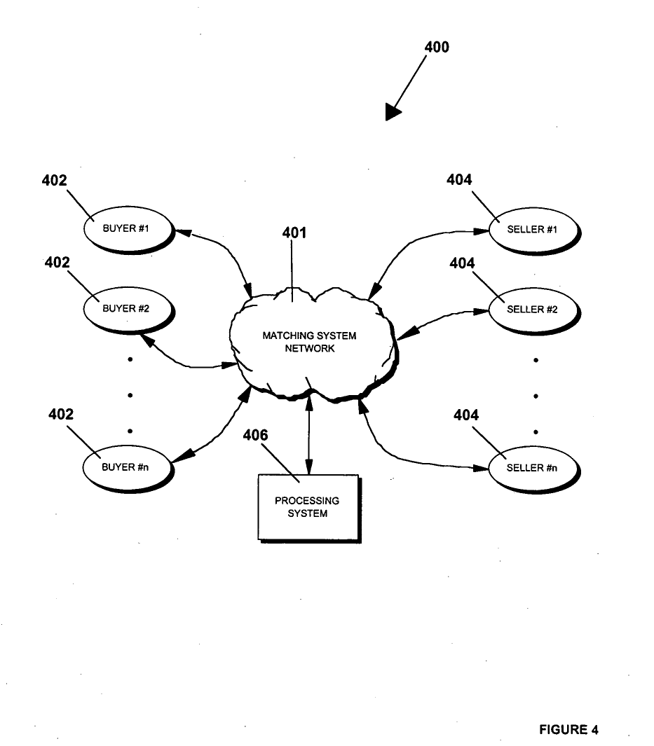

FIG. 6 provides one embodiment of a system implementing the profile links feature. As shown, in this embodiment a Profile link processor 602 is in communication with at least one database 604 and the Internet 606. The Profile link processor 602 may comprise any processor capable of handling the profiling and data manipulation features necessary to target sellers' goods/services to a buyer. As such, computer workstations, mainframe computers, servers, and other networked systems may be utilized as the Profile link processor. In the preferred embodiment, the Profile link processor utilizes a distributed architecture, thereby allowing multiple processing systems to provide the Profile links and various other marketing features of the present invention to a wide variety of buyers and sellers.

The system also includes a seller's system 608. The seller's system includes those devices necessary to connect a seller's computer workstation or other system to the Internet 606. Additionally, the seller's system 608 may be configured to communicate directly with the Profile link processing system 602, while bypassing the Internet via other communications links 620, as desired. The seller's system may be implemented on any Internet compatible device including pagers, telephone systems, lap-top computers, personal data assistants, and similar devices. Further, numerous profiles may be established for each buyer and seller. Such profiles may be task specific (i.e., they are utilized only when a user is accessing a particular template or data entry field) while other profiles may be generic to all buyers and sellers. For example, different profiles for a seller of trucking equipment may be established based upon locations of dealerships, option packages, price, delivery terms, and other terms. The process suitably receives, processes, stores, and manages such data to establish unique profiles as necessary.

The seller's system 608 also communicates via the Internet 606 or via other communications links 614 with an Internet Service Provider (ISP) 612 hosting an Internet application or web page, for example, the matching process of the present invention. As is appreciated by those skilled in the art, the ISP 612 may be any Internet site, application, or web page and is not to be construed as being limited to the matching process of the present invention or any other process. A seller may access the ISP 612 to provide profile information, respond to queries, or, for example, monitor web pages.

Similarly, a buyer's system 610 is also suitably connected via a link 622 to the Internet 606, and/or via a second communications link 616 to the ISP 612. As provided for the seller's system, the buyer's system 610 may be any device which provides Internet connectivity and the functions and features specified herein. Such devices include personal computers, personal computing devices, wireless telephones, interactive televisions, Internet equipped radio's, pagers, personal data assistants, and other devices.

The present invention facilitates targeted marketing based upon buyer and seller profiles, preferably obtained via an Internet or other network based system. As buyers and/or sellers respond to requests and responses, enter data, navigate the web, and perform other functions, the Profile link processor compiles such information and establishes profiles based thereon. The Profile link processor may provide numerous profiles for each buyer and seller, as desired.

Thus, the present invention additionally provides a method and system for providing targeted marketing to buyers based upon profiles of buyers and/or sellers. While the Profile link feature of the present invention has been depicted with reference to the process shown in FIG. 5 and the embodiment shown in FIG. 6, it is to be appreciated that the Profile link feature is not limited to any hardware configuration, software applications, or processes. The Profile link feature may be implemented on any system and may utilize any scheme, method, or system for utilizing buyer and/or seller profiles to target marketing to such buyers and/or sellers.

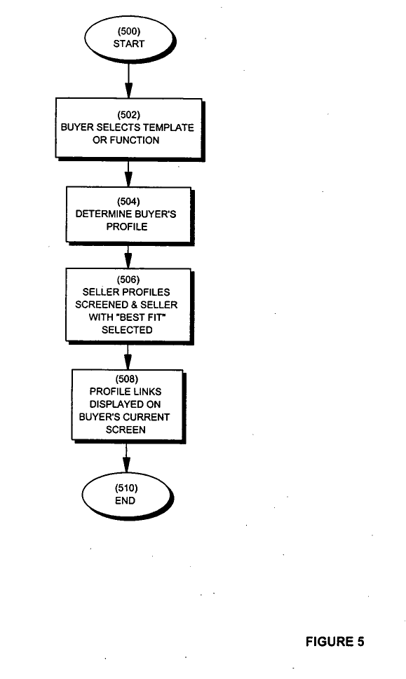

Referring now to FIGS. 7-18, one Internet Based Embodiment (IBE) of a system implementing the process of the present invention is provided. As shown in FIG. 7 and the figures thereafter, the IBE utilizes screen shots from an Internet based application provided by Wellogix™ and its predecessor WellBid™. Those skilled in the art appreciate, however, that embodiments of the present invention and the Wellogix/WellBid embodiments may vary substantially or insubstantially in the features and functions provided by such systems without departing from, modifying, adding, or deleting to the scope of the present invention as described herein and expressed in the claims.

As shown in FIG. 7, the IBE facilitates the entry of project specifications and buyer profile information in order to match buyers with sellers of goods/services in the oil and gas industry. More specifically, the IBE is initially accessed by inputting the appropriate uniform resource locator on a web browser connected to the Internet. As shown, upon accessing a server hosting the IBE, a main menu page 700 is displayed. This page 700 provides access by both a buyer and a seller, via an Internet connection, to the features and functions of the present. However, as discussed above, it is to be appreciated that this embodiment, and various other embodiments of the present invention, may be accessible via any network and system including, but not limited to, the Internet, intranet, private network, local area networks, wide area networks, distributed networks, and public networks. As shown, the main menu page provides links (via tabs, buttons, and hyperlinks) to various other screens (which are provided on various web pages). Further, the IBE preferably provides the before mentioned security and control features by utilizing a login name 702 and password 704 to control access. Additionally, various links to industry related information, and other information is provided, including an “Apply Today” link 706 by which a new user may apply to utilize the IBE.

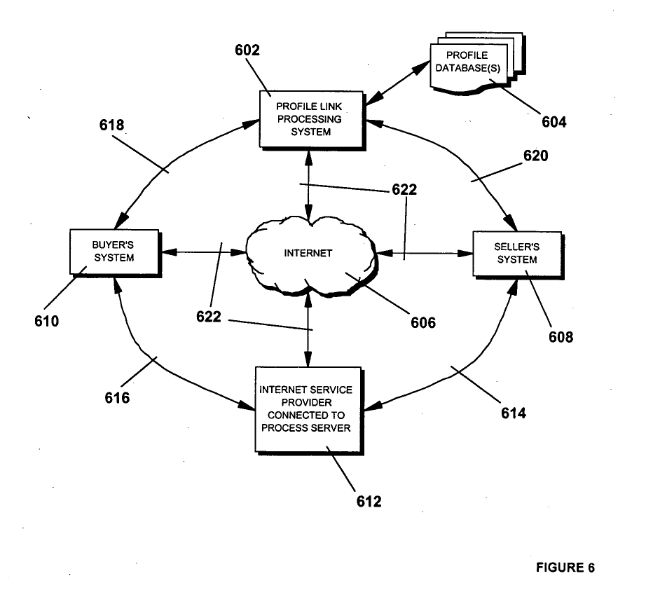

Upon a user selecting the Apply Today link 706, the IBE requests profile information from the person logging on. The information requested includes a name, address, login name, password, title, email address, region and basin (in which the user primarily operates—as is commonly used in the oil and gas industry), corporate affiliations (for example, if the user is an employee of XYZ gas company), and various other information. This information is then verified for its accuracy by a customer service employee and, upon verification, a user login name and password is created. FIG. 8 displays a representation of the user profile page 800, which contains user profile information that be suitably selected by “clicking” upon the appropriate drop down menu item 802 and entering data in the appropriate data fields 804. The use of drop down menus, buttons, hyper links, and data entry fields for obtaining profile and other information is well known in the art, and is not discussed further in reference to the IBE. As may be appreciated by those skilled in the art, various Internet links and pages may be accessed in any of a multitude of combinations and sequences. As such, the present description, for purposes of illustration only, is provided for one possible sequence of screen displays and data entry. It is to be appreciated that various other methods of entering and accessing information via the present invention and the IBE may be utilized without departing from the spirit or scope of the present invention.

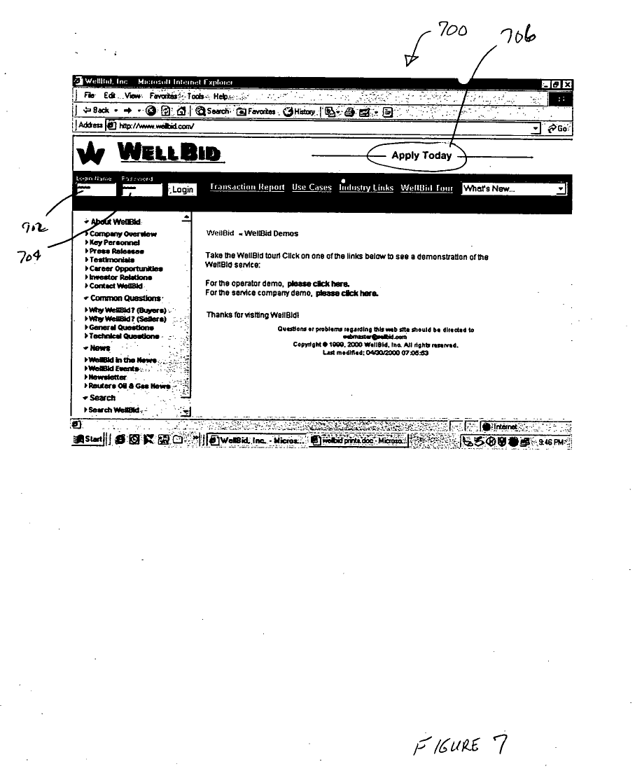

When a registered user (who is a buyer or a buyer team member, hereafter collectively referred to as a “Buyer”) logs onto the IBE, a page is displayed similar to that shown in FIG. 9. As shown, the Bid Request Summary page 900 provides, to the Buyer, the status of current requests (i.e., submitted, unsubmitted, and closed requests) while also identifying those requests for which corresponding responses (or replies) have been received. Further, by suitably selecting any of the underlined terms (hyperlinks), the Buyer is preferably transferred to a web page containing the identified information.

Further, this page 900 also contains links which display an “All Projects List” 902, a “Bid Request Summary” 904, Profile information selectable by a drop down menu 906, Projects information selectable by a drop down menu 908, a “Find a Consultant” link 910 which connects the Buyer with a web page providing a listing (and hyperlinks to home pages) of consultants in a given field or region, and various other links.

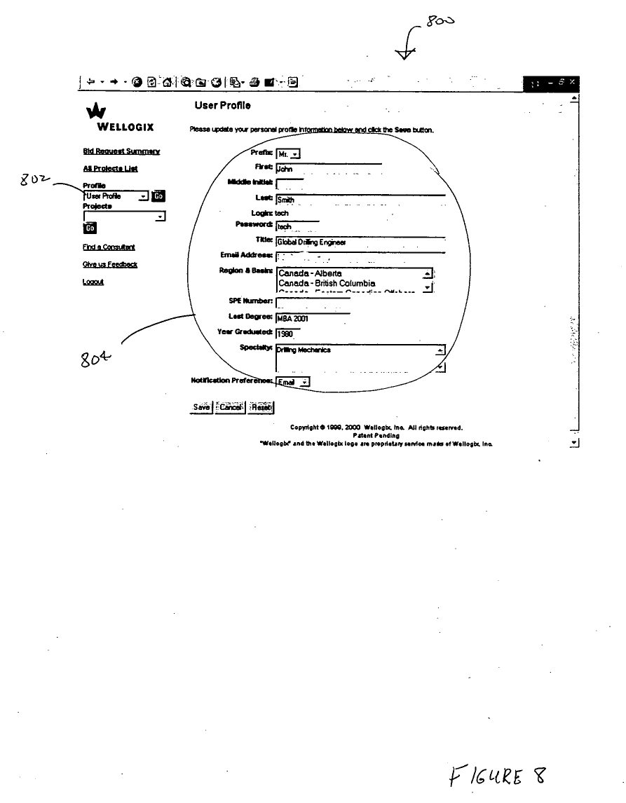

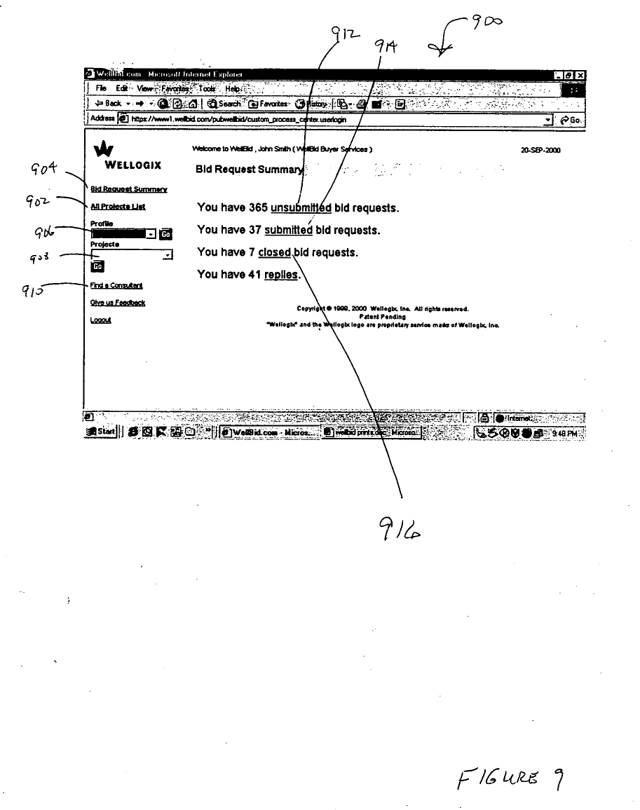

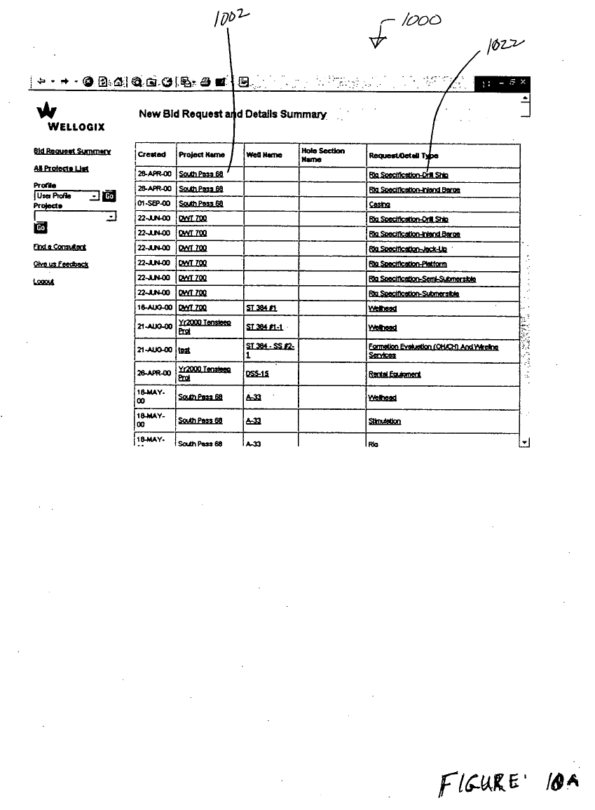

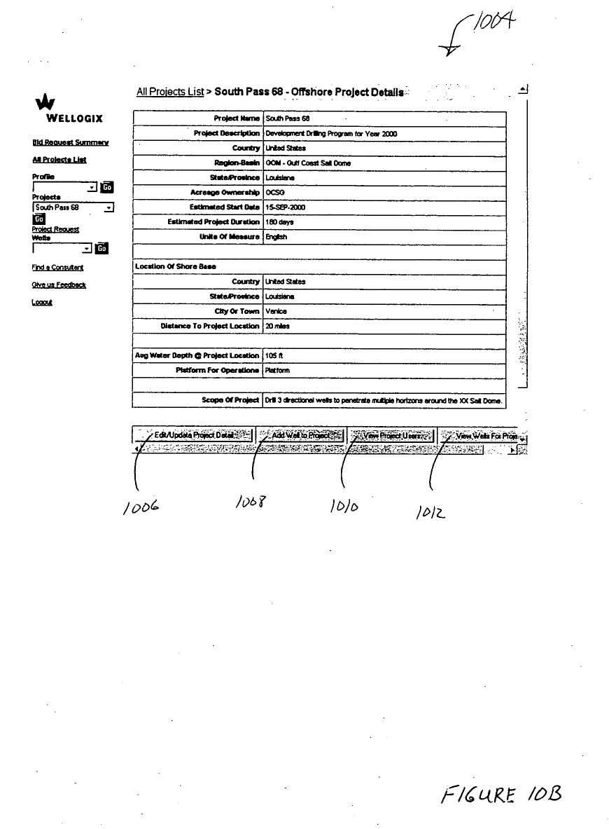

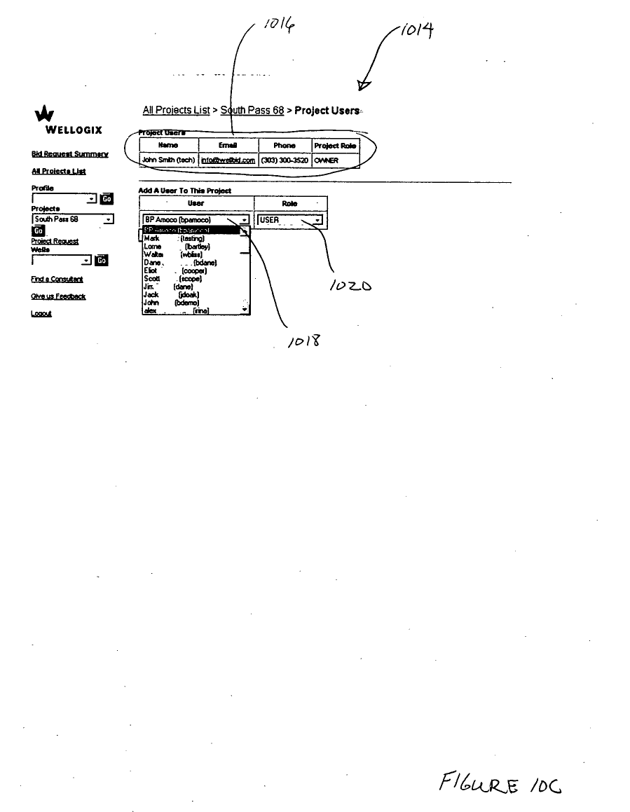

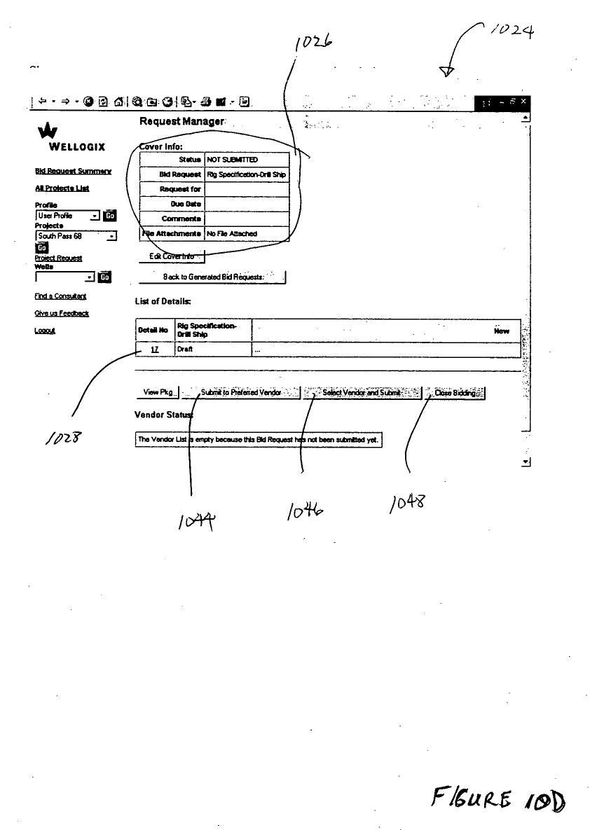

More specifically, when the Buyer selects the “unsubmitted” link 912, the IBE preferably displays the New Bid Request and Details Summary page 1000, as shown in FIG. 10A, which contains a listing of unsubmitted requests for goods/services and relevant summary information. By appropriately selecting the corresponding links, the Buyer may review the status of any of these projects, the well (as listed by name), the hole section, and the requested type of goods/services needed. For example, by selecting the “South Pass 68” link 1002 the system preferably presents to the Buyer project details for the South Pass 68 project via the page 1004 shown in FIG. 10B. As shown for this embodiment, the project details include a project name, project description, project location information, and other information relevant to an oil and gas project. Additionally, this page contains various “buttons” which allow the Buyer to “Edit/Update Project Detail” 1006, “Add Well to Project” 1008, “View Project Users” 1010, and “View Wells for Project” 1012. As stated previously, the present invention provides a Buyer with access to any information at any time desired. As represented by the previously identified buttons (1006-1012), the IBE incorporates a flexible database management system which permits access to information at various times from various web pages.

For example, when the Buyer selects the “View Project Users” button 1010, the IBE suitably displays the Project Users page 1014, which displays those Buyers on a specific buyer's team (the buyer is identified as the “owner” in the IBE) in a table 1016. Additionally, the system enables the buyer/owner to add or delete team members by selecting a specific person from a drop down menu 1018 and designating a role for the person via the menu 1020. The IBE allows as many team members as are desired to be added to a project by the buyer/owner. Additionally, the IBE preferably identifies possible team members when they enroll with the system. For example, all the Company QRS employees signed onto the IBE would be associated with a single pool of potential team members for a buyer/owner who also works for Company QRS, whereas Company JKL employees might not be so associated. Once the team members have been selected, the system preferably returns to the preceding page from which it progressed.

Referring again to FIG. 10A, the New Bid Request page 1000 also allows those Buyers with the requisite authority to view details for each request. For example, when the Rig Specification-Drill Ship request 1022 is selected, the Request Manager page 1024 is displayed (as shown in FIG. 10D). The system allows the Buyer to review and edit cover info (providing status information, naming the bid request, identifying which suppliers are to receive the request, a due date for responses to the request, comments, and identifying attachments 1026, all of which may be edited. Additionally, the page 1024 provides a listing of details for the request.

When a Detail (for example detail “17”) 1028 is selected, the IBE preferably displays the details for the request, as shown in FIG. 10E on the “CH Logging . . . ” details page 1030. In the IBE, each detail page also includes a Profile link 1032 which contains an identification of sellers for goods/services associated with a specific request (in this case CH logging). Additionally, the Profile link 1032 enables the Buyer to select specific sellers as preferred sellers, identify a sales person or point of contact, and, when available, includes a hyperlink (as underlined) to web pages providing information about a specific seller's goods/services. As mentioned previously, the present invention preferably targets marketing (in this case identifying sellers of goods/services associated with a specific oil field task) to a buyer based upon the buyer's profile information. For example, if the Buyer had previously identified a specific vendor as a non-preferred vendor, then the profile link would not display such a vendor to the Buyer. Similarly, if the Buyer identified a seller as a preferred vendor, then marketing information associated with the seller may be provided via the Profile link to the Buyer. Further, when the Buyer desires requests from any seller, marketing materials may be provided for all sellers, except preferably those previously identified by the Buyer as excluded, via the Profile link.

Further, each details page 1030 also includes data entry fields in which data may be entered and prompts answered (for example, a prompt 1034 whether production logging is needed). Additionally, as shown, the details page 1030 has been abbreviated from its actual length for purposes of simplifying this description. It is to be appreciated, however, that web pages of any size, length and complexity may be utilized in conjunction with the present invention and/or the IBE. Further, the IBE allows a Buyer to save the details as a final version or a draft, delete the details page, and reset the details to propagated values and/or baseline values/settings, when desired via buttons 1036.

Referring again to FIG. 10D, the IBE generates a bid package which identifies information about a request in addition to the specific goods/services needed. FIG. 10F provides an example of a portion of a Package page 1040. As shown, the IBE preferably packages a request into a document (electronic) which identifies, for example, the request, the project, and the well's names or names if more than one well is included in the package. The IBE allows numerous requests and/or details for specific tasks to be incorporated into a single package, when desired, thereby encouraging economies of scale and other savings. More specifically, the system allows a Buyer to obtain a bid from a supplier for any number of jobs (for example cementing jobs) on any number of wells instead of bidding out each well job independently. In addition to the various information entered or automatically propagated into the various data entry fields (the IBE preferably propagates information from previous data entry fields whenever possible; thereby streamlining the request process), the IBE also allows a Buyer to attach files and establish categories 1042 to which information related to a current request are attached. For example, the request for CH logging is related to casing information and tubing information. Referring again to FIG. 10D, the IBE also enables a Buyer to submit an unsubmitted bid to preferred sellers via button 1044, select sellers and then submit 1046, and close bidding 1048.

Referring again to FIG. 9, when Buyer selects the submitted bid requests link 914, the IBE preferably displays a list similar to that shown in FIG. 10A, except the requests have been submitted. As for the unsubmitted requests, the Buyer may access the requests and modify them as needed. However, when a submitted request is modified, it is preferably issued as an updated request or a new request, which reflects the changes to the old request. In this manner, both the Buyer and the seller can track how a request has been modified from previous revisions, when desired.

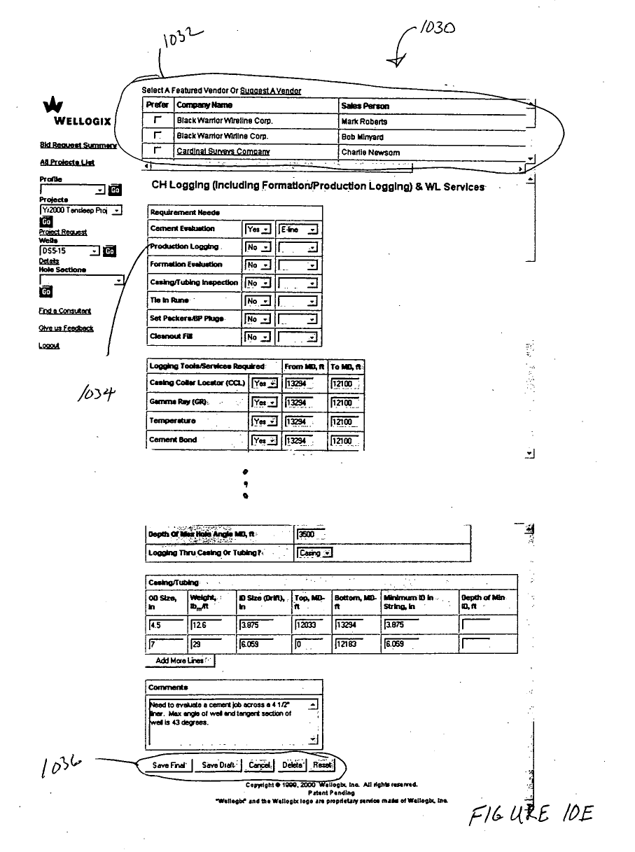

Upon submitting a request, the IBE leaves the request pending until the Buyer closes bidding, accepts a response from a seller to the request, or the request expires (as indicated by an expiration date). Whenever any of these events occur, the request enters the closed status. Upon selecting the closed bid requests link 916, the IBE preferably displays the Closed Bid page 1100, as shown in FIG. 11. As provided before, the Closed Bid page 1100 displays a table listing the bid requests by date, project name, well name, hole section name, and request/detail type.

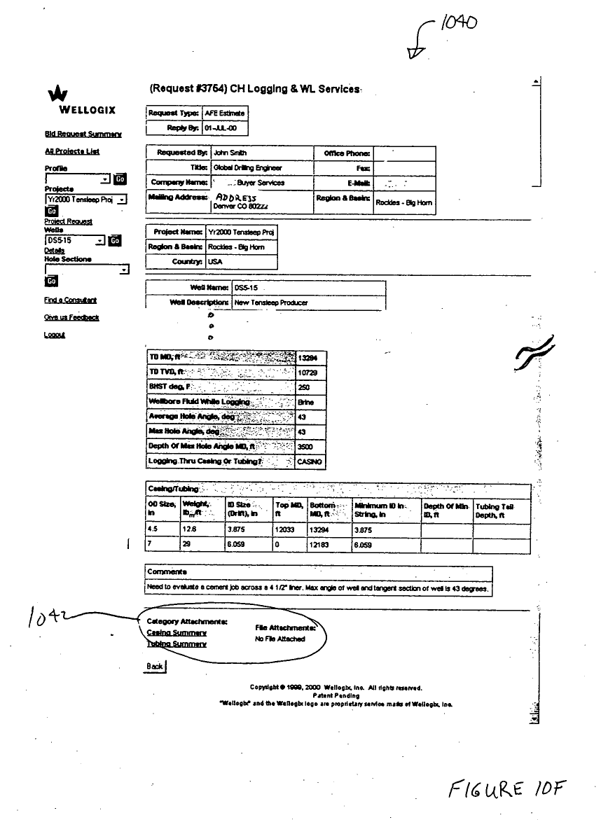

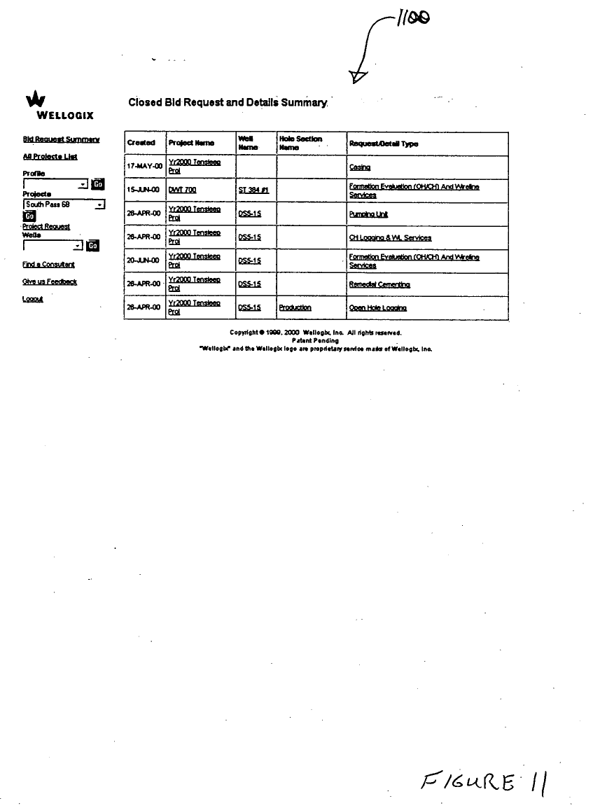

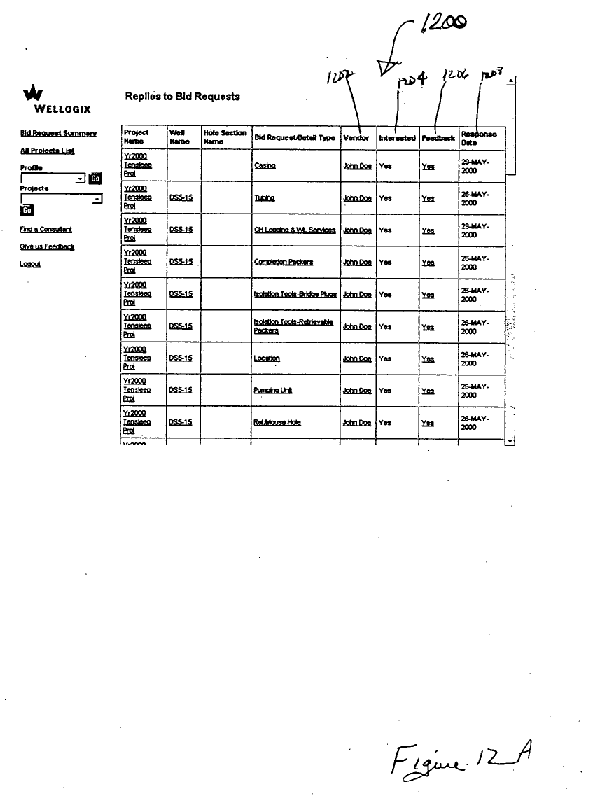

Referring again to FIG. 9, when a Buyer selects the replies link 918, the IBE preferably displays the Replies to Bids Requests page 1200, as shown in FIG. 12A, which identifies all the requests for which a reply/response by a seller has been provided. As provided before (with respect to the other bid types), this page 1200 provides a table which lists the bid requests by date, project name, well name, hole section name, and request/detail type. Additionally, page 1200 contains columns identifying the vendor/seller 1202 (hereafter, the vendor and/or seller and/or seller's team member are collectively referred to as the “Seller”, i.e., the person providing a response to a bid request), whether the Seller is interested in the request 1204 (yes or no), whether the Seller provided any feedback to the request 1206, and the response date 1208. Upon selecting a link provided in the vendor column 1202, the IBE suitably displays the Vendor Info page 1210, which obtains information on the selected Seller from a database and presents the information such that the Buyer may obtain contact information for the Seller.

FIG. 12C provides a depiction of a Vendor Feedback page 1212 which is displayed upon selecting a “Yes” link in the feedback column 1206 of FIG. 12A. As shown in FIG. 12C, the Vendor Feedback page 1212 provides a Comments field 1214 in which comments by a Seller have been entered regarding the bid request. These comments are preferably viewed by the Buyer prior to accepting a response to a request.

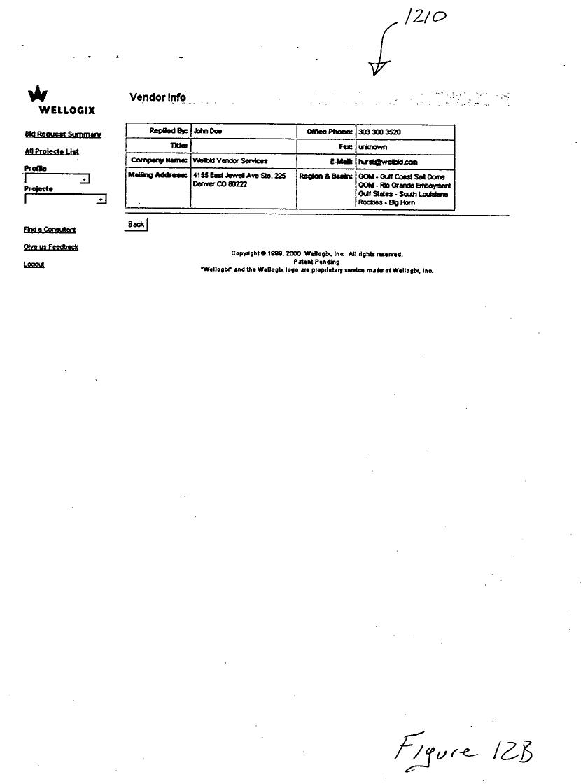

Referring once again to FIG. 9 and as mentioned previously, when a buyer accesses the IBE for a new session, the Bid Request Summary page 900 is preferably displayed. In addition to allowing review of bid requests and replies, this page 900 also enables a Buyer to access project details. More specifically, the project drop down menu 906 preferably enables a Buyer to select an existing project (which in the oil and gas embodiment preferably contains at least one well with at least one hole section), view all projects, or create a new project. When all projects are selected for viewing, the IBE displays the All Projects page 1300, as shown in FIG. 13. This page 1300 provides a table identifying projects by name, region, country, status and the Buyer's role. It also contains a “Create onshore project” button 1302 and a “Create offshore project” button 1304, which provides the same functionality as the corresponding selections provided in the project drop-down menu 906. Specifically, these buttons 1302 and 1304 enable a Buyer to create a new on-shore or off-shore project.

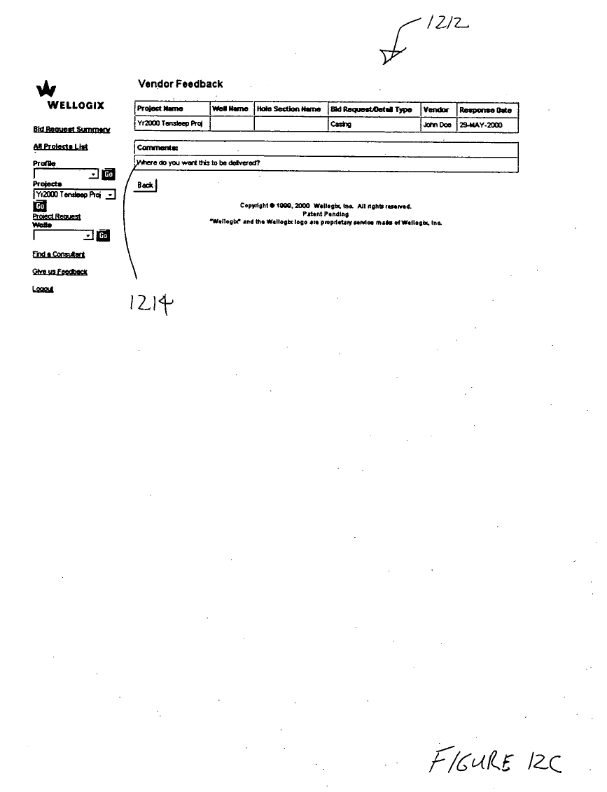

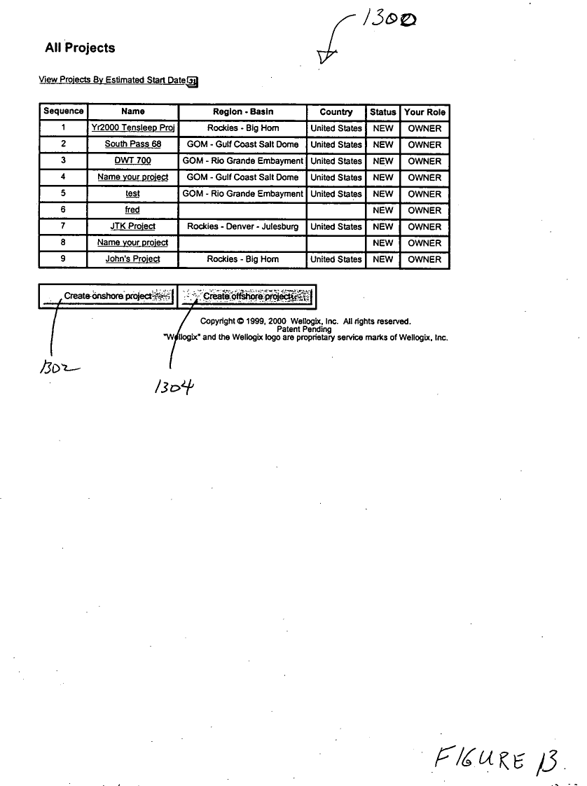

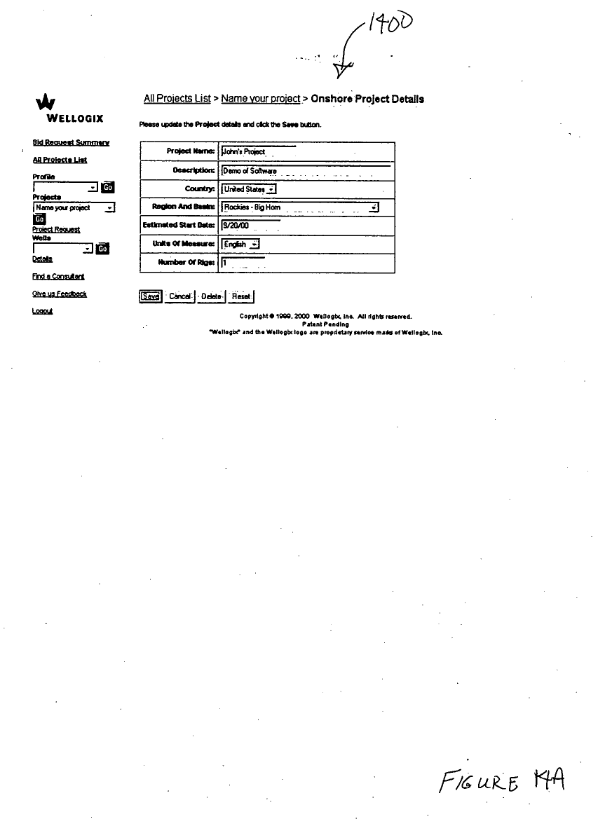

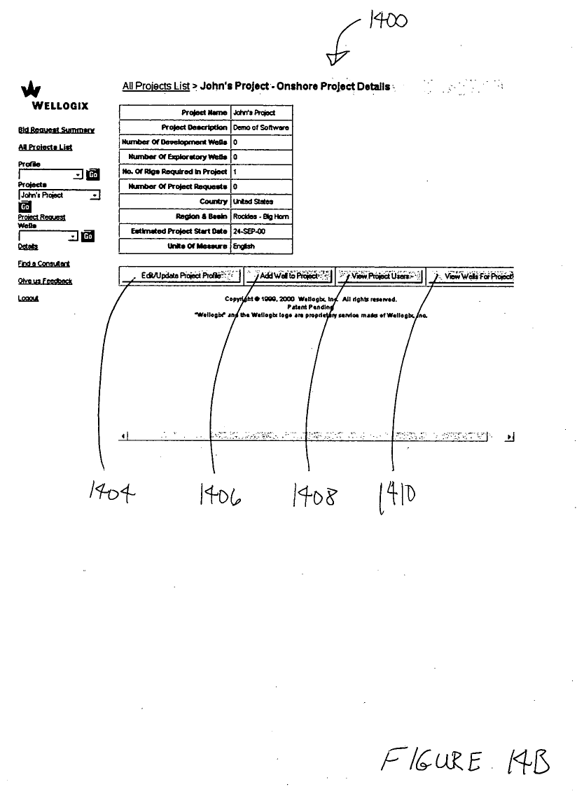

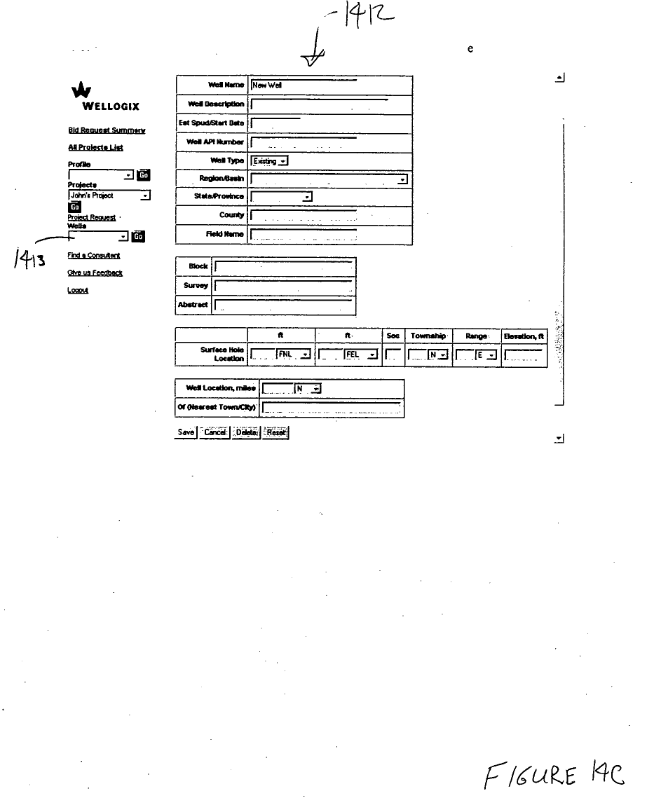

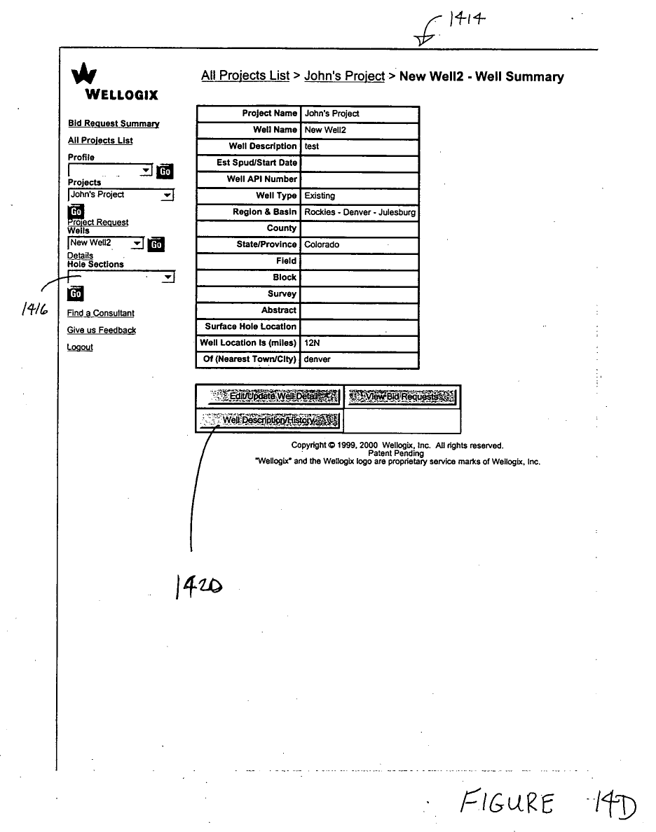

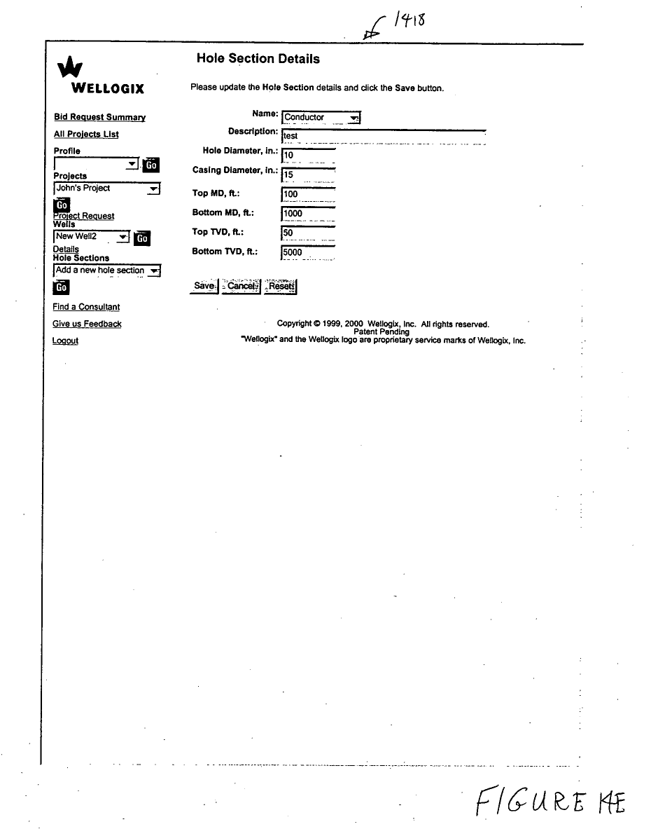

Assume for purposes of illustration, an on-shore project is desired to be created. Upon selecting the button 1302, or the corresponding entry in the projects drop-down menu, the IBE displays the On-Shore Project Details page 1400 shown in FIG. 14A. This page 1400 provides data entry fields for a project name (here, “John's Project”), a description, country, region and basin, estimated start date, units of measure, and number of rigs. Upon entering and saving, this information is utilized by the IBE to populate any subsequent page which needs the project details.

Further, upon saving the project details, the IBE redisplays the Project Details page 1400 while additionally including buttons to: Edit/Update Project Profile 1404; Add Well to Project 1406; View Project Users 1408; and View Wells for Project 1410, as shown in FIG. 14B. Since in the oil and gas embodiment, a project is basically a collection of wells, the Buyer generally will want to add a well to the project. Upon selecting the corresponding button 1406, the system preferably displays the Well Definition page 1412, as shown in FIG. 14C. The Well Definition page 1412, preferably contains fields in which a Buyer may enter information about a well including: well name, well description, well API number, well type, region/basin; and the location of the surface hole for the well using various measurement systems. Alternatively, instead of entering all of the information needed to define a well, the system also permits the Buyer to copy information provided for a different well into the new well definition by selecting and copying a predefined well via the well drop down menu 1413. In those situations where the Buyer desires to drill many wells using the same or similar techniques, the ability to copy well definitions can save significant time. Additionally, as before, the well information is preferably entered only once into the IBE as it is automatically and appropriately populated to future pages, as necessary.

Upon saving the information entered on the Well Definition page 1412, the IBE suitably displays a summary of the information previously entered on the Well Definition page 1412 as a Well Summary page 1414, as shown in FIG. 14D. Additionally, the system provides a drop down menu for Hole sections 1416, by which a Buyer may describe a hole section for the selected well. As shown in FIG. 14E, the Hole Section Details page 1418 provides fields in which information needed to define a well may be entered and saved. As is well known in the art, the process of defining a well may involve numerous hole sections. The IBE allows a Buyer (for example, a drilling engineer) to define and save each hole section. Referring once again to FIG. 14D, the IBE also allows a Buyer to view the history of a well's performance by selecting the Well Description/History button 1420, which results in displaying the Well Summary page 1422 shown in FIG. 14F. The history of a well is preferably captured in the IBE when drilling engineers, rig foreman, and other members of a drilling team provide update reports. As is common in the oil and gas industry, such update reports are preferably provided daily, however, any other time interval may be utilized including, for example, real-time updates, weekly updates, monthly updates, yearly updates, and updates upon completion of a project.

After the well and its various hole sections have been described, the IBE preferably allows a Buyer to also view all the wells for a project, select specific wells and display a geological prognosis for the well (preferably entered by a drilling engineer), for example, as shown in FIG. 14G. The Geological Prognosis page 1424 provides information on the well's layout including locations of the top hole, any horizontal sections, and the bottom hole. As such, this information, when combined with the other information for the well and the hole sections, provides the needed information to describe the project.

At this point, the Buyer is ready to generate requests for goods/services needed for the project. The IBE preferably provides a Buyer with numerous options for generating requests. Various aspects of the oil drilling industry are captured in the various request templates provided by the system including for example: CH drilling, mudding operations, casing, drilling fluids, and so forth. Upon generating a request (using templates similar to those previously discussed above), the Buyer directs the IBE to communicate the request to the designated sellers (or all sellers). At this point, the Buyer's actions needed to generate a request for goods/services have been completed. The Buyer then awaits a response, if any, from a Seller.

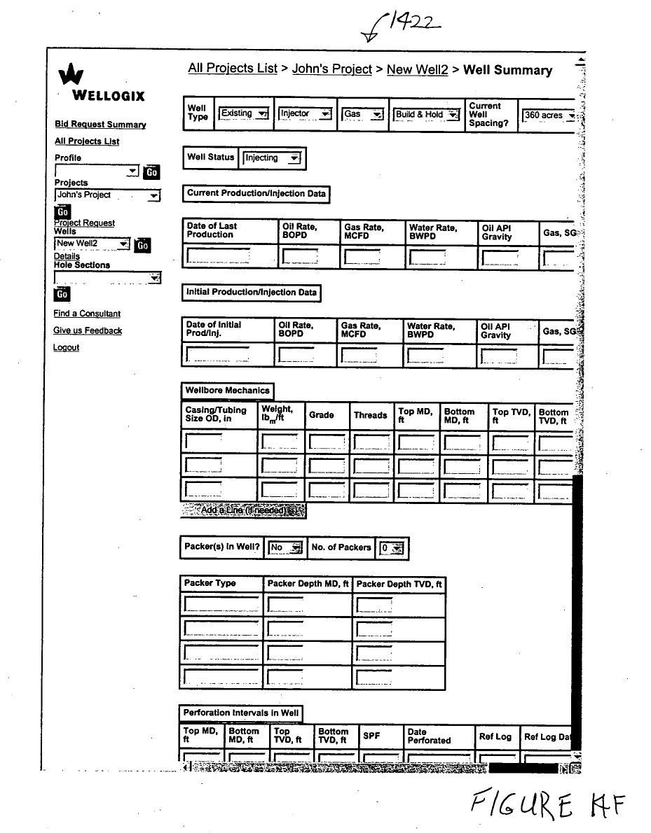

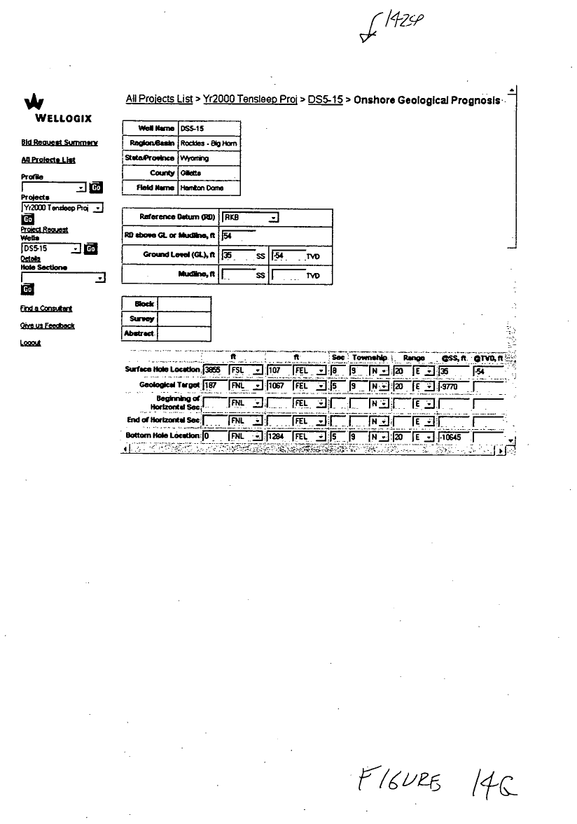

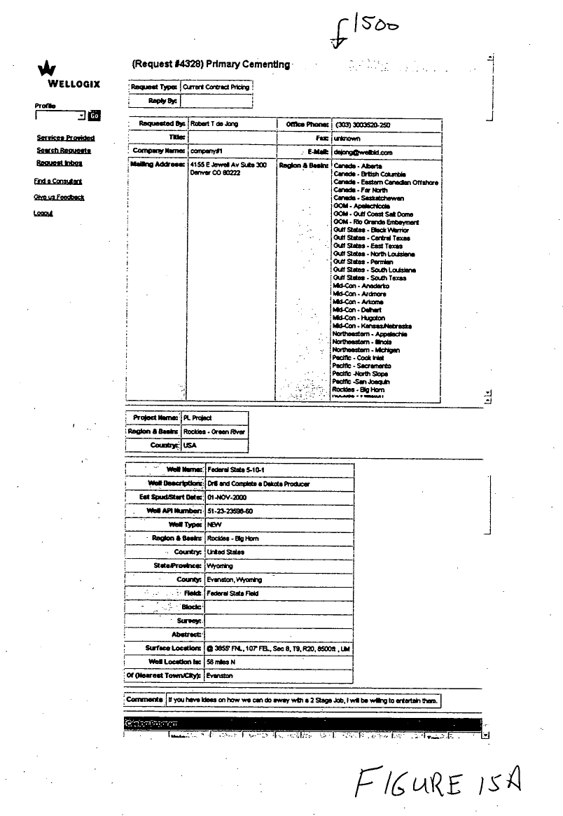

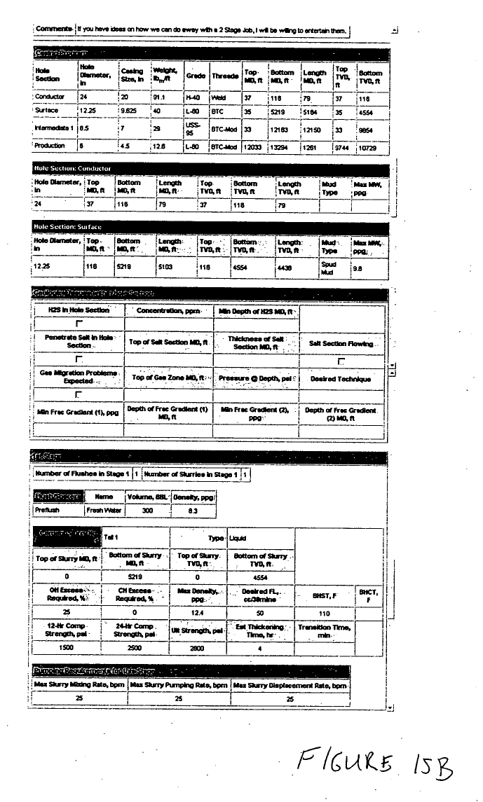

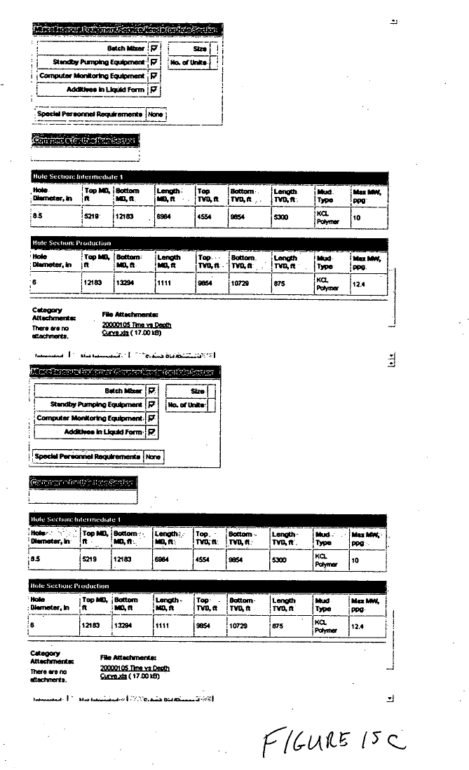

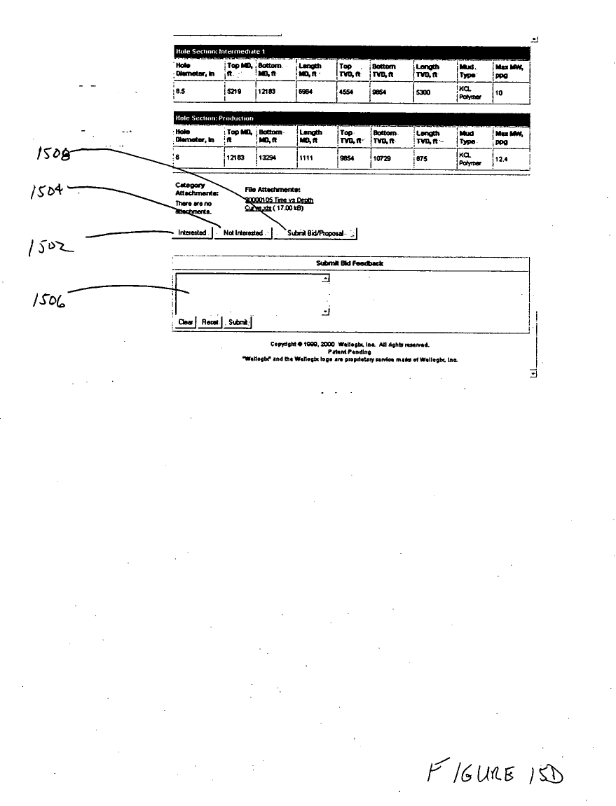

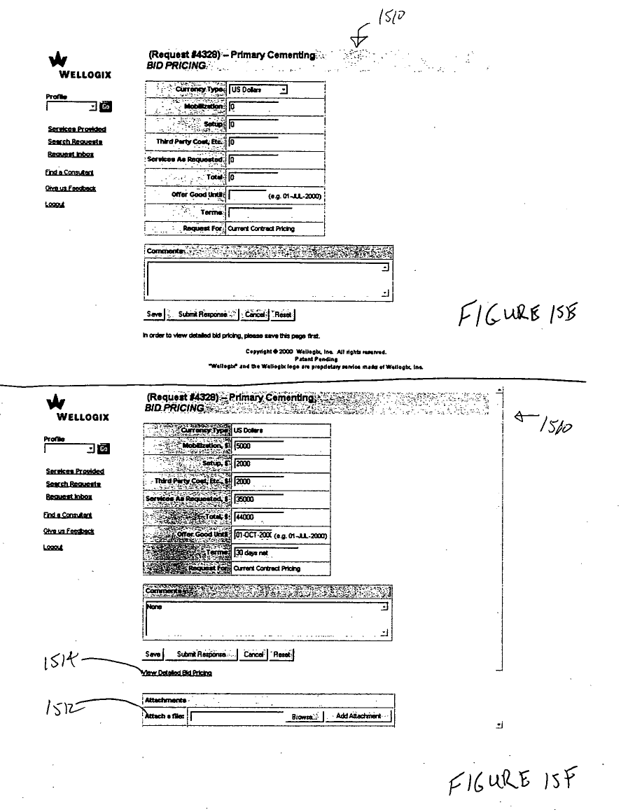

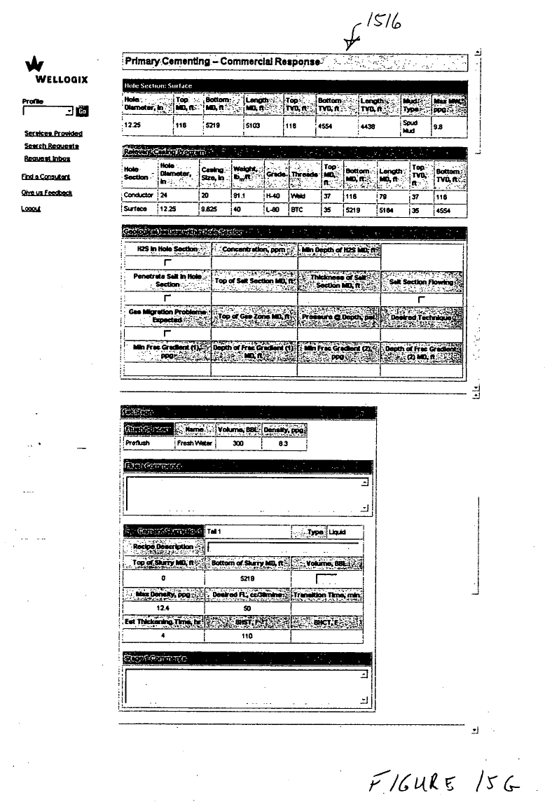

FIGS. 15A-D provides an example of a request which has been communicated to a seller (after being notified of its existence by the IBE). As shown the Primary Cementing page 1500 provides a request for primary cementing that includes information on all aspects of the well which are relevant to a primary cementing job. Upon receiving the request, the seller is provided with the options of: indicating that they are interested in the project, via the Interested button 1502 (FIG. 15D); indicating that they are not interested in the project, via the Not Interested button 1504; submitting feedback related to the project, via the feedback field 1508 and associated buttons (as seen earlier, the feedback may include requests for additional information, recommendations on alternative approaches, or any other information); and submitting a bid/response via the Submit Bid/Proposal button 1508. The interested, not interested, and feedback options provide a reply to the buyer which may then be suitably displayed and examined (as discussed earlier).

When the Seller selects the bid/proposal button 1508, however, the IBE proceeds to provide the Seller with a Bid Pricing page 1510, as shown in FIGS. 15E and 15F (FIG. 15F displaying a populated version of FIG. 15E). As shown, the Bid Pricing Page 1510 for cementing provides fields in which a Seller specifies a currency and various proposed costs for mobilization, set-up, third party costs, services, a total cost, an expiration date for the offer, terms, and other information. Upon entering this basic information, the IBE provides the seller with the option of attaching documents 1512, and/or viewing detailed bid/pricing templates 1514, as shown in the Primary Cementing—Commercial Response page 1516 shown in FIGS. 15G and 15H (FIG. 15H being a continuation of the screen display shown in FIG. 15G). Upon entering the appropriate costs into the detailed pricing page 1516, the Seller may then save the pricing and send the response to the Buyer.

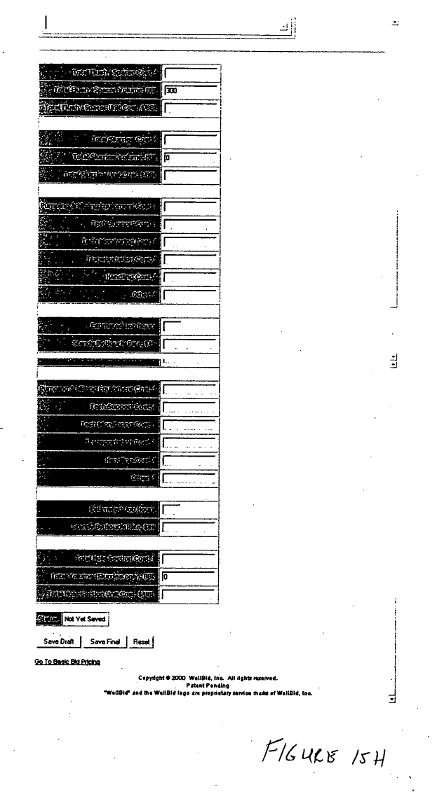

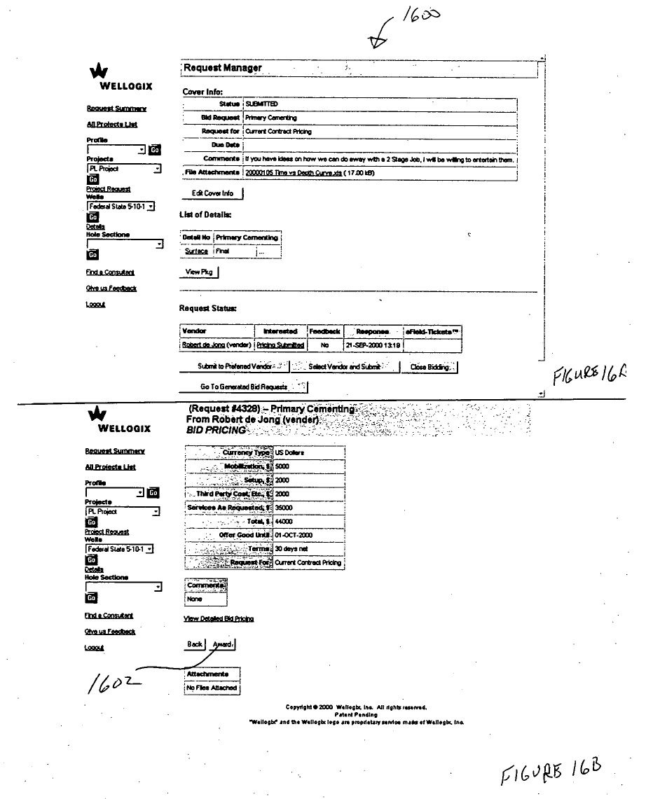

Upon receiving the response and accessing it via the Request Manager page 1600, as shown in FIG. 16A, the Buyer may then view the seller's bid/proposal as shown in FIG. 16B. If the seller's response is acceptable to the Buyer, the Buyer may accept the proposal by selecting the Award button 1602. Upon selection of the Award button 1602, the IBE finalizes a contract for the agreed upon goods/services between the buyer and the seller.

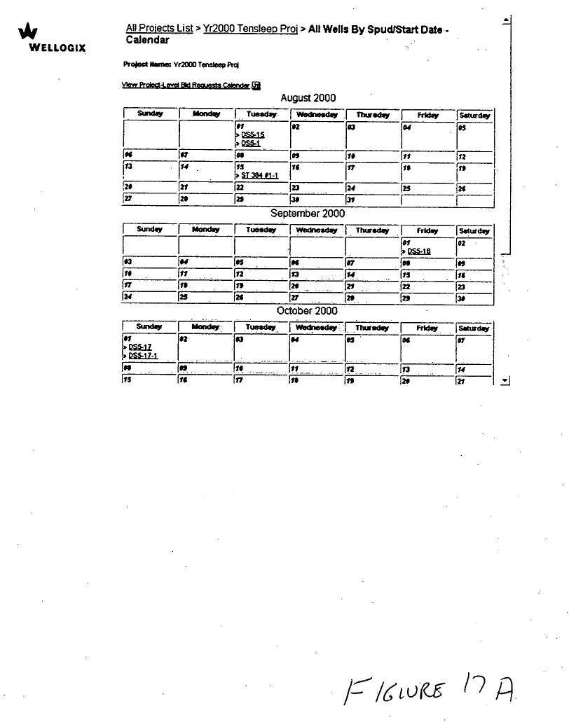

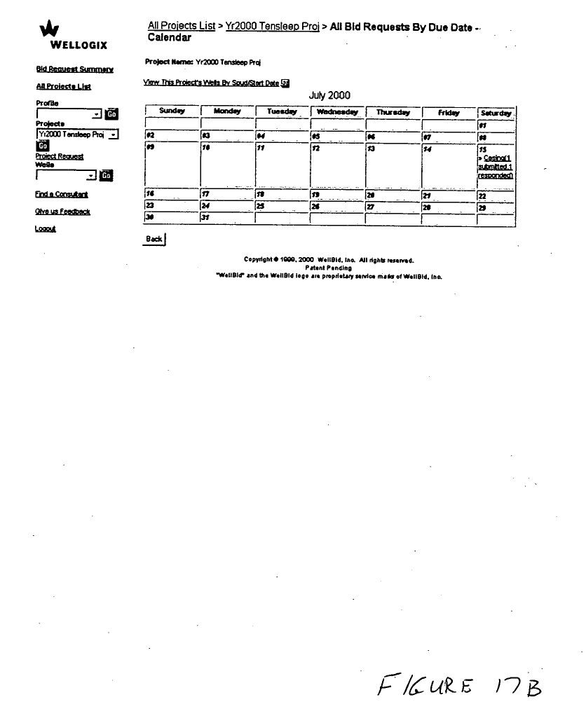

Additionally, the IBE allows the Buyer to display calendars depicting the dates when specific requests were submitted, when a request expires and other time sensitive information. FIG. 17A provides an example output of the calendaring function for wells by start date. Similarly, FIG. 17B provides an example of the calendaring function as applied to bid requests by due date. Those skilled in the art appreciate that the IBE and the present invention may be configured, as desired, to calendar any event, due dates, or other information.

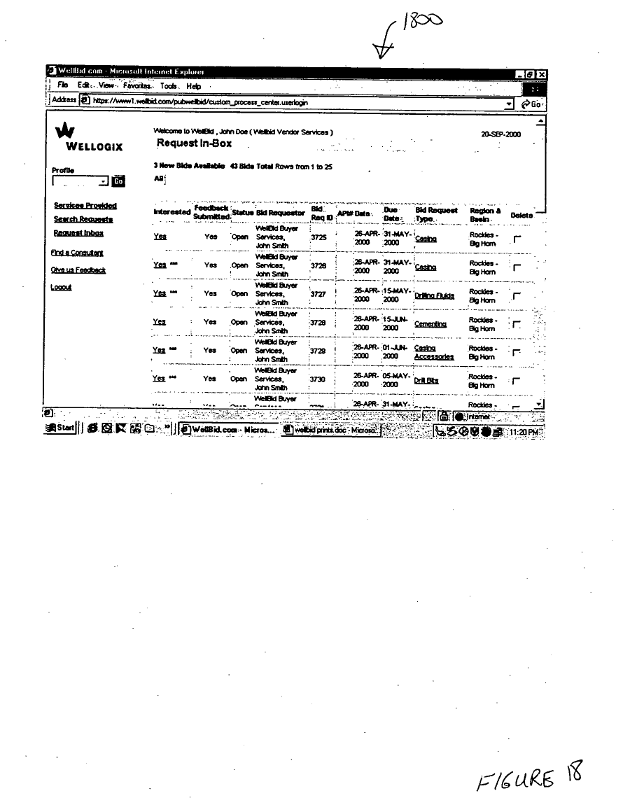

Lastly, the IBE provides Sellers with many of the functionalities provided to Buyers. For example, Sellers have the option of designating themselves as providers of specific goods/services. Additionally, Sellers can conduct searches for requests available for them to review—those requests designated by Buyers for only a list of preferred sellers are preferably not searchable by sellers not designated by the Buyer. Additionally, as Buyers change Parameters for a project, the sellers are suitably notified of such changes so that they may resubmit and/or revise bids as necessary. Finally, as shown in FIG. 18, via the Request In-Box page 1800, sellers are suitably notified by the IBE of outstanding requests, requests to which they have expressed an interest, and other information associated therewith. As such, the IBE specifically provides a fully interactive system for managing and entering into contracts for the oil and gas industry and generally provides a process and system for matching buyers and sellers for the provision of goods/services based upon Parameters.

While the systems and processes of the present invention have been described as encompassing numerous features, capabilities, architectures, and configurations, and depicted in detail for an Internet based embodiment, it is to be appreciated that the process of the present invention encompasses any and all combinations of these and comparable embodiments and is not to be construed as being limited to any preferred embodiment, or the IBE specified in detail herein. Additionally, modifications may be made to the process flow, techniques, equipment used, or any other element, factor, or step without departing from the scope of the present invention.

1. A computer readable medium containing instructions for generating a request for one or more goods/services to be provided by a seller to a buyer for a project, wherein the project is defined in terms of at least one of or more parameters, by:
defining a project in terms of at least one or more parameters;
converting the at least one or more parameters into at least one request for goods/services needed to complete the project, the at least one request comprising information derived from the at least one or more parameters, the information comprising at least one datum not among the at least one or more parameters; and
communicating the at least one request to at least one seller providing the goods/services needed for the project.

2. The computer readable medium of claim 1, wherein the computer readable medium is provided for use in conjunction with at least one project of a type selected from the group consisting of: oil exploration, construction, manufacturing complex objects, and providing specialized services.

3. The computer readable medium of claim 1, wherein the at least one or more parameters further comprise at least one parameter selected from the group consisting of: physical, functional, temporal, financial, transactional, and geographical parameters.

4. The computer readable medium of claim 1, wherein the request is communicated to the seller via a system accessible via a network connection.

5. The computer readable medium of claim 4, wherein the network further comprises at least one network selected from the group consisting of: the Internet, intranet, private network, public network, local area network, wide area network, and a distributed network.

6. The computer readable medium of claim 5, wherein the network is carried over one or more communication systems selected from the group consisting of: telephony, wireless telephony, satellite, and cable.

7. A computer readable medium containing instructions for generating a response by a seller to at least one request from a buyer for one or more goods/services for a project, by:
preparing a response by the seller, wherein the response responds to a request from a buyer, the request identifying at least one good/services specified for the project defined in terms of at least one parameter, the request comprising information derived from the at least one parameter, the information comprising at least one datum not among the at least one parameter; and
communicating a response to the buyer.

8. The computer readable medium of claim 7, wherein the project further comprises at least one project of a type selected from the group consisting of: oil exploration, construction, manufacturing complex objects, and providing specialized services.

9. The computer readable medium of claim 7, wherein the parameters are selected from the group consisting of: physical, functional, temporal, financial, transactional, and geographical parameters.

10. The computer readable medium of claim 7, wherein the instructions further include communicating the response to the buyer via a system accessible via a network connection.

11. The computer readable medium of claim 10, wherein the network further comprises at least one network selected from the group consisting of: the Internet, intranet, private network, public network, local area network, wide area network, and a distributed network.

12. The computer readable medium of claim 11, wherein the network is carried over one or more communication systems selected from the group consisting of: telephony, wireless telephony, satellite, and cable.

13. A computer readable medium containing instructions for facilitating the matching buyers and sellers for goods/services specified for a project defined in terms of at least one parameter, by:
receiving an identification of a project defined in terms of at least one parameter from a buyer;
converting the project into a request for goods/services, the request comprising information defined from the at least one parameter, the information comprising at least one datum not among the at least one parameter;
communicating the request to a seller; and
communicating a response to the buyer, wherein the response is provided by the seller in response to the request and the response identifies at least one goods/services offered to be provided by the seller to the buyer for the project;
whereupon acceptance of the response by the buyer, a contract for the goods/services specified in the response is formed between the buyer and the seller.

14. The computer readable medium of claim 13, wherein the project further comprises at least one of a type selected from the group consisting of: oil exploration, construction, manufacturing complex objects, and providing specialized services.

15. The computer readable medium of claim 13, wherein the at least one parameter further comprise at least one parameter selected from the group consisting of: physical, functional, temporal, financial, transactional, and geographical parameters.

16. The computer readable medium of claim 13, wherein the request is communicated to the seller and the response is communicated to the buyer via a network selected from the group consisting of: the Internet, intranet, private network, public network, local area network, wide area network, and a distributed network.

17. The computer readable medium of claim 13, wherein the instructions further comprise notifying the seller that a request is available for review, wherein the seller is notified via at least one communication medium selected from the group consisting of: electronic mail, facsimile, page, telephone notification, and a networked notification message.

18. The computer readable medium of claim 13, wherein the instructions further comprise notifying the buyer that a response is available for review, wherein the buyer is notified via at least one communication medium selected from the group consisting of: electronic mail, facsimile, page, telephone notification, and a networked notification message.

19. The computer readable medium of claim 13, wherein the instructions further comprise entering into negotiations between the buyer and seller regarding at least one term in the response.

20. The computer readable medium of claim 19, wherein the negotiations are conducted electronically over a network connection.

21. The computer readable medium of claim 20, wherein the network connection further comprises at least one network selected from the group consisting of: the Internet, intranet, private network, public network, local area network, wide area network, and a distributed network.
